(19) United States
(12) Patent Application Publication
(10) Pub. No.: US 2023/0132867 A1
(43) Pub. Date: May 4, 2023

(54) ADJUSTABLE SHADING MODULE

(71) Applicant: CHIEN-HSUN LAI, Taichung City (TW)

(72) Inventor: CHIEN-HSUN LAI, Taichung City (TW)

(21) Appl. No.: 17/825,731

(22) Filed: May 26, 2022

Related U.S. Application Data
(60) Provisional application No. 63/272,922, filed on Oct. 28, 2021.

(51) Int. Cl. G03B 17/12; H04N 5/225

(52) U.S. Cl. CPC G03B 17/12; H04N 5/2254; G03B 2205/0069

(57) ABSTRACT

An adjustable shading module includes a base, an optical image capturing system, and at least one shading cover. The base has an optical mounting portion and a cover mounting portion that are integrally formed. The optical mounting portion has a chamber and a through-hole communicating with the chamber. The cover mounting portion is located on a side of the optical mounting portion. The optical image capturing system has an optical lens assembly disposed in the chamber and having an optical axis and at least two lenses arranged in order along the optical axis from an object side to an image side. The object side of the optical lens assembly faces the through-hole. The optical axis passes through the through-hole. The shading cover is disposed on the cover mounting portion and is movable on a moving path, which is not parallel to the optical axis, to close or open the through-hole.

### BACKGROUND OF THE INVENTION

### Technical Field

The present invention relates generally to an optical system, and more particularly to a miniaturized optical lens module which has a shading component and is adapted to be applied to an electronic device.

### Description of Related Art

In recent years, with the rise of portable electronic devices having camera functionalities, the demand for an optical lens module is raised gradually. The image sensor of the ordinary optical systems is commonly selected from charge coupled device (CCD) or complementary metal-oxide semiconductor sensor (CMOS Sensor). In addition, as advanced semiconductor manufacturing technology enables the minimization of the pixel size of the image sensor, the development of the optical image capturing system towards the field of high pixels. Therefore, the requirement for high imaging quality is rapidly raised.

The conventional optical system of the portable electronic device usually has two lenses. However, the conventional optical system can no longer meet higher-level photography requirements as the portable electronic products continue to increase the pixel size and consumers demand large aperture to take pictures in a dark environment. 3

### BRIEF SUMMARY OF THE INVENTION

The aspect of embodiment of the present disclosure directs to an adjustable shading module which could improve imaging total pixels and imaging quality for image formation and could be applied to minimized electronic products.

The term and its definition to the lens parameter in the embodiments of the present disclosure are shown as below for further reference.

The lens parameter related to a length or a height in the lens:

A maximum height for image formation of the adjustable shading module is denoted by HOI. A height of the adjustable shading module is denoted by HOS. A distance from the object-side surface of the first lens to the image-side surface of the last lens is denoted by InTL. A distance on the optical axis between the aperture and the image plane is denoted by InS. A distance from the first lens to the second lens is denoted by IN12 (for instance). A central thickness of the first lens of the adjustable shading module on the optical axis is denoted by TP1 (for instance).

The lens parameter related to a material of the lens:

An Abbe number of the first lens in the adjustable shading module is denoted by NA1 (for instance). A refractive index of the first lens is denoted by Nd1 (for instance).

The lens parameter related to a view angle in the lens:

A view angle is denoted by AF. Half of the view angle is denoted by HAF. A major light angle is denoted by MRA.

The lens parameter related to exit/entrance pupil in the lens:

An entrance pupil diameter of the adjustable shading module is denoted by HEP. For any surface of any lens, a maximum effective half diameter (EHD) is a perpendicular distance between an optical axis and a crossing point on the surface where the incident light with a maximum viewing angle of the adjustable shading module passing the very edge of the entrance pupil. For example, the maximum effective half diameter of the object-side surface of the first lens is denoted by EHD11, the maximum effective half diameter of the image-side surface of the first lens is denoted by EHD12, the maximum effective half diameter of the object-side surface of the second lens is denoted by EHD21, the maximum effective half diameter of the image-side surface of the second lens is denoted by EHD22, and so on. In the adjustable shading module, a maximum effective diameter of the image-side surface of the lens closest to the image plane is denoted by PhiA, which satisfies the condition: PhiA=2*EHD. If said surface is aspheric, a cut-off point of the maximum effective diameter is a cut-off point containing the aspheric surface. An ineffective half diameter (IHD) of any surface of one single lens refers to a surface segment between cut-off points of the maximum effective half diameter of the same surface extending in a direction away from the optical axis, wherein said cut-off point is an end point of the surface having an aspheric coefficient if said surface is aspheric. In the adjustable shading module, a maximum diameter of the image-side surface of the lens closest to the image plane is denoted by PhiB, which satisfies the condition: PhiB=2*(maximum effective half diameter EHD+maximum ineffective half diameter IHD)=PhiA+2*(maximum ineffective half diameter IHD).

In the adjustable shading module, a maximum effective diameter of the image-side surface of the lens closest to the image plane (i.e., the image space) could be also called optical exit pupil, and is denoted by PhiA. If the optical exit pupil is located on the image-side surface of the third lens, then it is denoted by PhiA3; if the optical exit pupil is located on the image-side surface of the fourth lens, then it is denoted by PhiA4; if the optical exit pupil is located on the image-side surface of the fifth lens, then it is denoted by PhiA5; if the optical exit pupil is located on the image-side surface of the sixth lens, then it is denoted by PhiA6. If the optical image capturing system has more lenses with different refractive powers, the optical exit pupil of each lens is denoted in this manner. The pupil magnification ratio of the adjustable shading module is denoted by PMR, which satisfies the condition: PMR=PhiA/HEP.

The lens parameter related to an arc length of the shape of a surface and a surface profile:

For any surface of any lens, a profile curve length of the maximum effective half diameter is, by definition, measured from a start point where the optical axis of the belonging adjustable shading module passes through the surface of the lens, along a surface profile of the lens, and finally to an end point of the maximum effective half diameter thereof. In other words, the curve length between the aforementioned start and end points is the profile curve length of the maximum effective half diameter, which is denoted by ARS. For example, the profile curve length of the maximum effective half diameter of the object-side surface of the first lens is denoted by ARS11, the profile curve length of the maximum effective half diameter of the image-side surface of the first lens is denoted by ARS12, the profile curve length of the maximum effective half diameter of the object-side surface of the second lens is denoted by ARS21, the profile curve length of the maximum effective half diameter of the image-side surface of the second lens is denoted by ARS22, and so on.

For any surface of any lens, a profile curve length of a half of the entrance pupil diameter (HEP) is, by definition, measured from a start point where the optical axis of the belonging adjustable shading module passes through the surface of the lens, along a surface profile of the lens, and finally to a coordinate point of a perpendicular distance where is a half of the entrance pupil diameter away from the optical axis. In other words, the curve length between the aforementioned stat point and the coordinate point is the profile curve length of a half of the entrance pupil diameter (HEP), and is denoted by ARE. For example, the profile curve length of a half of the entrance pupil diameter (HEP) of the object-side surface of the first lens is denoted by ARE11, the profile curve length of a half of the entrance pupil diameter (HEP) of the image-side surface of the first lens is denoted by ARE12, the profile curve length of a half of the entrance pupil diameter (HEP) of the object-side surface of the second lens is denoted by ARE21, the profile curve length of a half of the entrance pupil diameter (HEP) of the image-side surface of the second lens is denoted by ARS22, and so on.

The lens parameter related to a depth of the lens shape:

A displacement from a point on the object-side surface of the sixth lens, which is passed through by the optical axis, to a point on the optical axis, where a projection of the maximum effective semi diameter of the object-side surface of the sixth lens ends, is denoted by InRS61 (the depth of the maximum effective semi diameter). A displacement from a point on the image-side surface of the sixth lens, which is passed through by the optical axis, to a point on the optical axis, where a projection of the maximum effective semi diameter of the image-side surface of the sixth lens ends, is denoted by InRS62 (the depth of the maximum effective semi diameter). The depth of the maximum effective semi diameter (sinkage) on the object-side surface or the image-side surface of any other lens is denoted in the same manner.

The lens parameter related to the lens shape:

A critical point C is a tangent point on a surface of a specific lens, and the tangent point is tangent to a plane perpendicular to the optical axis and the tangent point cannot be a crossover point on the optical axis. Following the above description, a distance perpendicular to the optical axis between a critical point CM on the object-side surface of the fifth lens and the optical axis is HVT51 (instance), and a distance perpendicular to the optical axis between a critical point C52 on the image-side surface of the fifth lens and the optical axis is HVT52 (instance). A distance perpendicular to the optical axis between a critical point C61 on the object-side surface of the sixth lens and the optical axis is HVT61 (instance), and a distance perpendicular to the optical axis between a critical point C62 on the image-side surface of the sixth lens and the optical axis is HVT62 (instance). A distance perpendicular to the optical axis between a critical point on the object-side or image-side surface of other lenses and the optical axis is denoted in the same manner.

The object-side surface of the seventh lens has one inflection point IF711 which is nearest to the optical axis, and the sinkage value of the inflection point IF711 is denoted by SGI711 (instance). A distance perpendicular to the optical axis between the inflection point IF711 and the optical axis is HIF711 (instance). The image-side surface of the seventh lens has one inflection point IF721 which is nearest to the optical axis, and the sinkage value of the inflection point IF721 is denoted by SGI721 (instance). A distance perpendicular to the optical axis between the inflection point IF721 and the optical axis is HIF721 (instance).

The object-side surface of the seventh lens has one inflection point IF712 which is the second nearest to the optical axis, and the sinkage value of the inflection point IF712 is denoted by SGI712 (for instance). A distance perpendicular to the optical axis between the inflection point IF712 and the optical axis is HIF712 (for instance). The image-side surface of the seventh lens has one inflection point IF722 which is the second nearest to the optical axis, and the sinkage value of the inflection point IF722 is denoted by SGI722 (for instance). A distance perpendicular to the optical axis between the inflection point IF722 and the optical axis is HIF722 (for instance).

The object-side surface of the seventh lens has one inflection point IF713 which is the third nearest to the optical axis, and the sinkage value of the inflection point IF713 is denoted by SGI713 (for instance). A distance perpendicular to the optical axis between the inflection point IF713 and the optical axis is HIF713 (for instance). The image-side surface of the seventh lens has one inflection point IF723 which is the third nearest to the optical axis, and the sinkage value of the inflection point IF723 is denoted by SGI723 (for instance). A distance perpendicular to the optical axis between the inflection point IF723 and the optical axis is HIF723 (for instance).

The object-side surface of the seventh lens has one inflection point IF714 which is the fourth nearest to the optical axis, and the sinkage value of the inflection point IF714 is denoted by SGI714 (for instance). A distance perpendicular to the optical axis between the inflection point IF714 and the optical axis is HIF714 (for instance). The image-side surface of the seventh lens has one inflection point IF724 which is the fourth nearest to the optical axis, and the sinkage value of the inflection point IF724 is denoted by SGI724 (for instance). A distance perpendicular to the optical axis between the inflection point IF724 and the optical axis is HIF724 (for instance).

An inflection point, a distance perpendicular to the optical axis between the inflection point and the optical axis, and a sinkage value thereof on the object-side surface or image-side surface of other lenses is denoted in the same manner.

The lens parameter related to an aberration:

Optical distortion for image formation in the adjustable shading module is denoted by ODT. TV distortion for image formation in the adjustable shading module is denoted by TDT. Further, the range of the aberration offset for the view of image formation may be limited to 50%-100% field. An offset of the spherical aberration is denoted by DFS. An offset of the coma aberration is denoted by DFC.

The present invention provides an adjustable shading module, in which the lens closest to the image plane is provided with an inflection point at the object-side surface or at the image-side surface to adjust the incident angle of each view field and modify the ODT and the TDT. In addition, the surfaces of the sixth lens are capable of modifying the optical path to improve the imagining quality.

The present invention provides an adjustable shading module, including an optical lens assembly including at least two lenses with refractive power, an image plane, and a first lens positioning member including a lens holder and a base, wherein the lens holder is hollow and opaque for shielding the optical lens assembly; the base is disposed in a direction close to the image plane to shield the image plane. The optical lens assembly satisfies: 1.0≤f/HEP≤10.0; 0°<HAF≤150°; and 0 mm<PhiD≤18 mm; wherein a maximum length of a shortest edge of a plane around the base perpendicular to the optical axis is denoted by PhiD; f is a focal length of the optical lens assembly; HEP is an entrance pupil diameter of the optical lens assembly; HAF is a half of a maximum view angle of the optical lens assembly.

The present invention further provides an adjustable shading module, including an optical lens assembly including at least two lenses with refractive power, an image plane, a first lens positioning member including a lens holder and a base, and a second lens positioning member disposed in the lens holder and including a positioning portion, wherein the lens holder is hollow and opaque for shielding the optical lens assembly. The base is disposed in a direction close to the image plane to shield the image plane. The positioning portion is hollow for receiving the optical lens assembly to allow the lens to be arranged in an optical axis. An outside of the positioning portion is not in contact with an inside of the positioning portion. The optical lens assembly satisfies: 1.0≤f/HEP≤10.0; 0°<HAF≤150°; 0 mm<PhiD≤18 mm; and 0 mm<TH1+TH2≤1.5 mm; wherein a maximum length of a shortest edge of a plane around the base perpendicular to the optical axis is denoted by PhiD; a maximum outer diameter of the positioning portion on the plane around an image side and perpendicular to the optical axis is denoted by PhiC; f is a focal length of the optical lens assembly; HEP is an entrance pupil diameter of the optical lens assembly; HAF is a half of a maximum view angle of the optical lens assembly; a maximum thickness of the base is denoted by TH1, and a minimum thickness of the positioning portion is denoted by TH2.

The present invention further provides an adjustable shading module, including an optical lens assembly including at least two lenses with refractive power, an image plane, and a first lens positioning member including a lens holder and a base, wherein the lens holder is hollow and opaque for shielding the optical lens assembly. The base is disposed in a direction close to the image plane to shield the image plane. The optical lens assembly satisfies: 1.0≤f/HEP≤10.0; 0°<HAF≤150°; 0 mm<PhiD≤18 mm; and 0 mm<TH1≤0.3 mm; wherein a maximum length of a shortest edge of a plane around the base perpendicular to the optical axis is denoted by PhiD; f is a focal length of the optical lens assembly; HEP is an entrance pupil diameter of the optical lens assembly; HAF is a half of a maximum view angle of the optical lens assembly; a maximum thickness of the base is denoted by TH1.

For any surface of any lens, the profile curve length within the effective half diameter affects the ability of the surface to correct aberration and differences between optical paths of light in different fields of view. With longer profile curve length, the ability to correct aberration is better. However, the difficulty of manufacturing increases as well. Therefore, the profile curve length within the effective half diameter of any surface of any lens has to be controlled. The ratio between the profile curve length (ARS) within the effective half diameter of one surface and the thickness (TP) of the lens, which the surface belonged to, on the optical axis (i.e., ARS/TP) has to be particularly controlled. For example, the profile curve length of the maximum effective half diameter of the object-side surface of the first lens is denoted by ARS11, the thickness of the first lens on the optical axis is TP1, and the ratio between these two parameters is ARS11/TP1; the profile curve length of the maximum effective half diameter of the image-side surface of the first lens is denoted by ARS12, and the ratio between ARS12 and TP1 is ARS12/TP1. The profile curve length of the maximum effective half diameter of the object-side surface of the second lens is denoted by ARS21, the thickness of the second lens on the optical axis is TP2, and the ratio between these two parameters is ARS21/TP2; the profile curve length of the maximum effective half diameter of the image-side surface of the second lens is denoted by ARS22, and the ratio between ARS22 and TP2 is ARS22/TP2. For any surface of other lenses in the adjustable shading module, the ratio between the profile curve length of the maximum effective half diameter thereof and the thickness of the lens which the surface belonged to is denoted in the same manner.

For any surface of any lens, the profile curve length within a half of the entrance pupil diameter (HEP) affects the ability of the surface to correct aberration and differences between optical paths of light in different fields of view. With longer profile curve length, the ability to correct aberration is better. However, the difficulty of manufacturing increases as well. Therefore, the profile curve length within a half of the entrance pupil diameter (HEP) of any surface of any lens has to be controlled. The ratio between the profile curve length (ARE) within a half of the entrance pupil diameter (HEP) of one surface and the thickness (TP) of the lens, which the surface belonged to, on the optical axis (i.e., ARE/TP) has to be particularly controlled. For example, the profile curve length of a half of the entrance pupil diameter (HEP) of the object-side surface of the first lens is denoted by ARE11, the thickness of the first lens on the optical axis is TP1, and the ratio between these two parameters is ARE11/TP1; the profile curve length of a half of the entrance pupil diameter (HEP) of the image-side surface of the first lens is denoted by ARE12, and the ratio between ARE12 and TP1 is ARE12/TP1. The profile curve length of a half of the entrance pupil diameter (HEP) of the object-side surface of the second lens is denoted by ARE21, the thickness of the second lens on the optical axis is TP2, and the ratio between these two parameters is ARE21/TP2; the profile curve length of a half of the entrance pupil diameter (HEP) of the image-side surface of the second lens is denoted by ARE22, and the ratio between ARE22 and TP2 is ARE22/TP2. For any surface of other lenses in the adjustable shading module, the ratio between the profile curve length of a half of the entrance pupil diameter (HEP) thereof and the thickness of the lens which the surface belonged to is denoted in the same manner.

The present invention provides an adjustable shading module, including a base, an optical image capturing system, and at least one shading cover, wherein the base has an optical mounting portion and a cover mounting portion that are integrally formed as a monolithic unit. The optical mounting portion has a chamber and a through-hole communicating with the chamber. The cover mounting portion is located on a side of the optical mounting portion. The optical image capturing system has an optical lens assembly having an optical axis and at least two lenses, wherein the at least two lenses are arranged in order along an optical axis from an object side to an image side. The optical lens assembly is disposed in the chamber, and an object side of the optical lens assembly faces towards the through-hole, and the optical axis passes through the through-hole. The at least one shading cover is disposed on the cover mounting portion and is movable along a moving path to close or open the through-hole, wherein the moving path is not parallel to the optical axis. The optical lens assembly satisfies: 1.0≤f/HEP≤10.0 and 0 deg<HAF≤150 deg, wherein f is a focal length of the optical lens assembly; HEP is an entrance pupil diameter of the optical lens assembly; HAF is a half of a maximum view angle of the optical lens assembly.

The present invention provides an adjustable shading module, including a base, an optical image capturing system, and at least one shading cover, wherein the base has an optical mounting portion and a cover mounting portion that are integrally formed as a monolithic unit. The optical mounting portion has a chamber and a through-hole communicating with the chamber. The cover mounting portion is located on a side of the optical mounting portion. The optical image capturing system has an optical lens assembly and an image sensor. The optical lens assembly has an optical axis and at least two lenses arranged in order along an optical axis from an object side to an image side. The optical lens assembly is disposed in the chamber, wherein an object side of the optical lens assembly faces towards the through-hole, and the optical axis passes through the through-hole. The image sensor is disposed in the chamber and is located at an image plane of the optical lens assembly. The at least one shading cover is disposed on the cover mounting portion and is movable along a moving path to close or open the through-hole, wherein the moving path is not parallel to the optical axis. The optical lens assembly satisfies: 0.5≤HOS/f≤150 and 1.0≤f/HEP≤10.0, wherein a distance on the optical axis between an object-side surface of one of the at least two lenses closest to the object side and the image sensor is denoted by HOS; f is a focal length of the optical lens assembly; HEP is an entrance pupil diameter of the optical lens assembly.

With the aforementioned design, the at least one shading cover could move on the moving path to close or open the through-hole, thereby switching the optical image capturing system between an open state and a closed state. When the optical image capturing system is in the closed state, the at least one shading cover blocks ambient light from entering the optical mage capturing system through the through-hole. When the optical image capturing system is in the open state, the at least one shading cover allows ambient light to enter the optical mage capturing system through the through-hole. In this way, the adjustable shading module could be easily and directly installed and applied to various portable electronic products.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the adjustable shading module according to an embodiment of the present invention;

FIG. 2 is a top view of FIG. 1;

FIG. 3 is a sectional view along the 3-3 line in FIG. 2;

FIG. 4 is a schematic view, showing the adjustable shading module shown in FIG. 3;

FIG. 5 is similar to FIG. 3, showing the adjustable shading module according to another embodiment of the present invention;

FIG. 6 is similar to FIG. 3, showing the adjustable shading module according to still another embodiment of the present invention;

FIG. 7 is similar to FIG. 3, showing the adjustable shading module according to still another embodiment of the present invention;

FIG. 8 is a schematic view, showing the adjustable shading module shown in FIG. 7;

FIG. 9 is similar to FIG. 3, showing the adjustable shading module according to still another embodiment of the present invention;

FIG. 10 is a schematic view, showing the adjustable shading module shown in FIG. 9;

FIG. 11 is similar to FIG. 3, showing the adjustable shading module according to still another embodiment of the present invention;

FIG. 12 is a schematic view, showing the adjustable shading module shown in FIG. 11;

FIG. 13 is similar to FIG. 3, showing the adjustable shading module according to still another embodiment of the present invention;

FIG. 14 is similar to FIG. 3, showing the adjustable shading module according to still another embodiment of the present invention;

FIG. 15 is similar to FIG. 3, showing the adjustable shading module according to still another embodiment of the present invention;

FIG. 16 is similar to FIG. 3, showing the adjustable shading module according to still another embodiment of the present invention;

FIG. 17 is a schematic view, showing the adjustable shading module shown in FIG. 16;

FIG. 18 is a schematic view, showing the adjustable shading module shown

FIG. 19 is a schematic view, showing the adjustable shading module shown in FIG. 16;

FIG. 20 is similar to FIG. 3, showing the adjustable shading module according to still another embodiment of the present invention;

FIG. 21 is similar to FIG. 3, showing the adjustable shading module according to still another embodiment of the present invention;

FIG. 22 is similar to FIG. 3, showing the adjustable shading module according to still another embodiment of the present invention;

FIG. 23 is similar to FIG. 3, showing the adjustable shading module according to still another embodiment of the present invention;

FIG. 24 is similar to FIG. 3, showing the adjustable shading module shown in FIG. 7;

FIG. 25A is a schematic diagram of the optical image capturing system according to a first optical embodiment of the present invention;

FIG. 25B shows curve diagrams of longitudinal spherical aberration, astigmatic field curves, and distortion in order from left to right according to the first optical embodiment of the present invention;

FIG. 26A is a schematic diagram of the optical image capturing system according to a second optical embodiment of the present invention;

FIG. 26B shows curve diagrams of longitudinal spherical aberration, astigmatic field curves, and distortion in order from left to right according to the second optical embodiment of the present invention;

FIG. 27A is a schematic diagram of the optical image capturing system according to a third optical embodiment of the present invention;

FIG. 27B shows curve diagrams of longitudinal spherical aberration, astigmatic field curves, and distortion in order from left to right according to the third optical embodiment of the present invention;

FIG. 28A is a schematic diagram of the optical image capturing system according to a fourth optical embodiment of the present invention;

FIG. 28B shows curve diagrams of longitudinal spherical aberration, astigmatic field curves, and distortion in order from left to right according to the fourth optical embodiment of the present invention;

FIG. 29A is a schematic diagram of the optical image capturing system according to a fifth optical embodiment of the present invention;

FIG. 29B shows curve diagrams of longitudinal spherical aberration, astigmatic field curves, and distortion in order from left to right according to the fifth optical embodiment of the present invention;

FIG. 30A is a schematic diagram of the optical image capturing system according to a sixth optical embodiment of the present invention;

FIG. 30B shows curve diagrams of longitudinal spherical aberration, astigmatic field curves, and distortion in order from left to right according to the sixth optical embodiment of the present invention;

FIG. 31A is a schematic view, showing the adjustable shading module of the present invention is applied to the mobile communication device;

FIG. 31B is a schematic view, showing the adjustable shading module of the present invention is applied to the laptop;

FIG. 31C is a schematic view, showing the adjustable shading module of the present invention is applied to the smart watch;

FIG. 31D is a schematic view, showing the adjustable shading module of the present invention is applied to the smart headset;

FIG. 31E is a schematic view, showing the adjustable shading module of the present invention is applied to the security monitoring device;

FIG. 31F is a schematic view, showing the adjustable shading module of the present invention is applied to the vehicle video device;

FIG. 31G is a schematic view, showing the adjustable shading module of the present invention is applied to the drone; and

FIG. 31H is a schematic view, showing the adjustable shading module of the present invention is applied to the extreme sports video device.

### DETAILED DESCRIPTION OF THE INVENTION

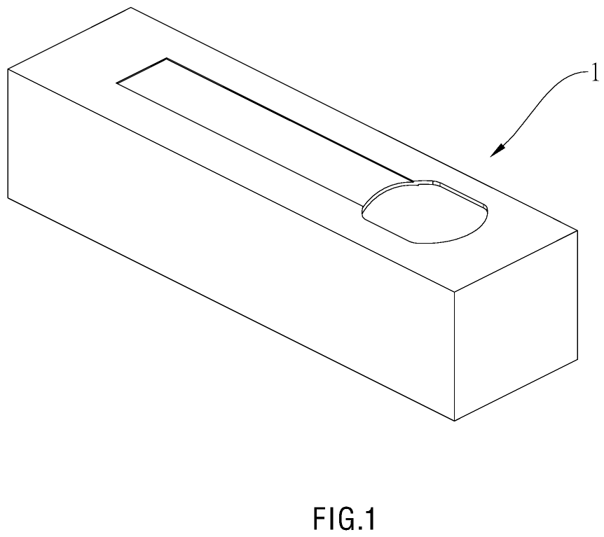

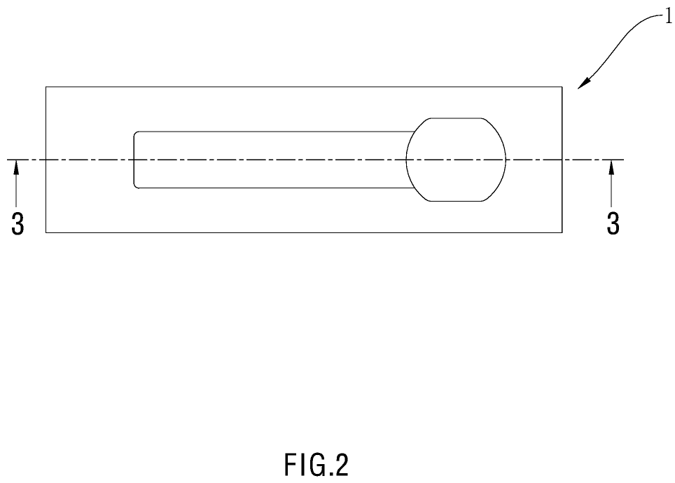

An adjustable shading module of an embodiment of the present invention is illustrated in FIG. 1 to FIG. 3 and includes an optical image capturing system 10, a base 12, and a shading cover 13, wherein the base 12 has an optical mounting portion 12a and a cover mounting portion 12b that are integrally formed as a monolithic unit. The base 12 could be made of, for example, Liquid Crystal Polyme (LCP) materials, or Polycarbonate plastic material and glass fiber, wherein the base made of Polycarbonate plastic material and glass fiber could have a better molding fluidity to avoid injection deformation and shrinkage problems, and could improve a toughness of the materials to avoid deformation after assembled.

The optical mounting portion 12a has a chamber R1 and a through-hole H1 communicating with the chamber R1. The cover mounting portion 12b is located on a side of the optical mounting portion 12a. The optical image capturing system 10 includes an optical lens assembly 101, wherein the optical lens assembly 101 has an optical axis A and at least two lenses L arranged in order along the optical axis A from an object side to an image side. The optical lens assembly 101 is disposed in the chamber R1, and the object side of the optical lens assembly 101 faces towards the through-hole H1, wherein the optical axis A passes through the through-hole H1. The shading cover 13 is disposed on the cover mounting portion 12b and is movable on a moving path to close or open the through-hole H1, wherein the moving path is not parallel to the optical axis A. The optical lens assembly 101 satisfies: 1.0≤f/HEP≤10.0 and 0 deg <HAF≤150 deg, wherein f is a focal length of the optical lens assembly 101; HEP is an entrance pupil diameter of the optical lens assembly 101; HAF is a half of a maximum view angle of the optical lens assembly 101. The optical lens assembly 101 includes three to eight lenses with refractive power and satisfies: 0.1≤InTL/HOS≤0.95, wherein a distance on the optical axis A between the image plane and an object-side surface of one of the lenses that is the closest to the object side is denoted by HOS; a distance from the object-side surface of one of the lenses that is the closest to the object side to an image-side surface of one of the lenses that is the closest to the image side is denoted by InTL. The optical lens assembly 101 further includes an aperture and satisfies: 0.2≤InS/HOS≤1.1, wherein a distance on the optical axis A between the aperture and the image plane is denoted by InS.

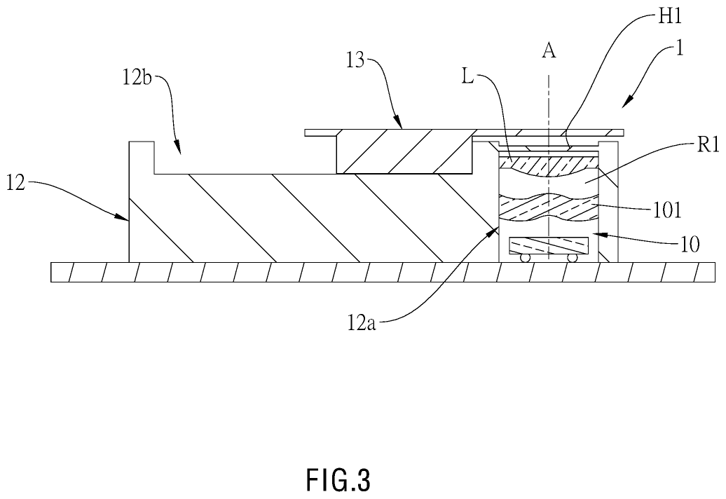

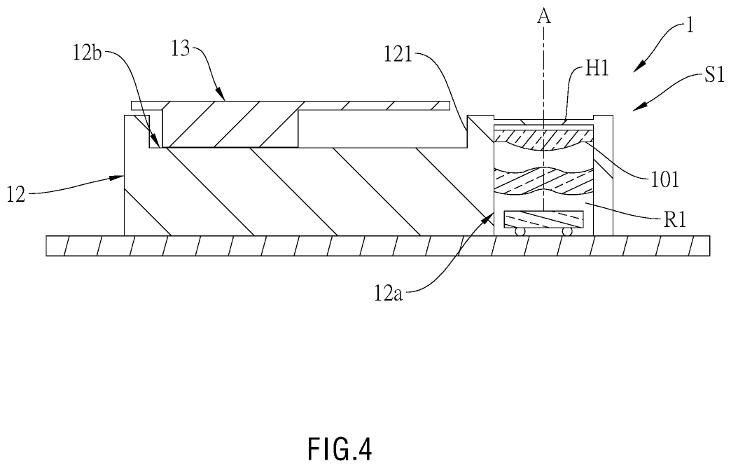

With the shading cover 13 that could move on the moving path to close or open the through-hole H1, the optical image capturing system 10 could be switched between an open state S1 and a closed state S2. Referring to FIG. 3, the shading cover 13 blocks ambient light from entering the optical image capturing system 10 through the through-hole H1 when the optical image capturing system 10 is in the closed state S2. Referring to FIG. 4, the shading cover 13 allows ambient light to enter the optical image capturing system 10 through the through-hole H1 when the optical image capturing system 10 is in the open state S1. In the current embodiment, the number of the shading cover 13 is one as an example. In practice, the number of the shading cover 13 could be more than one.

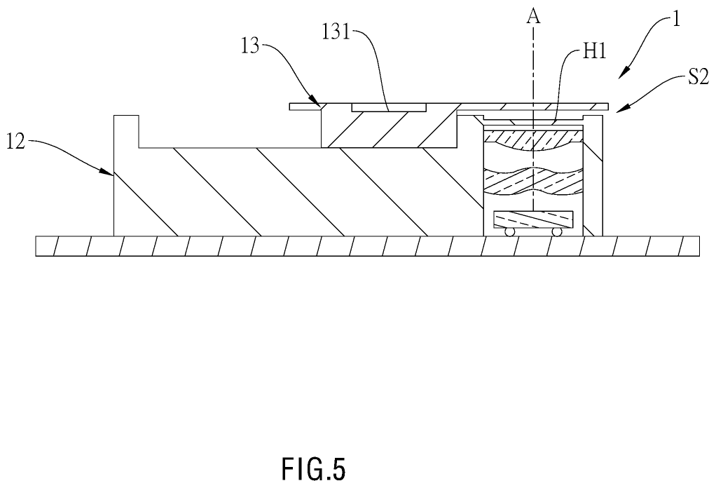

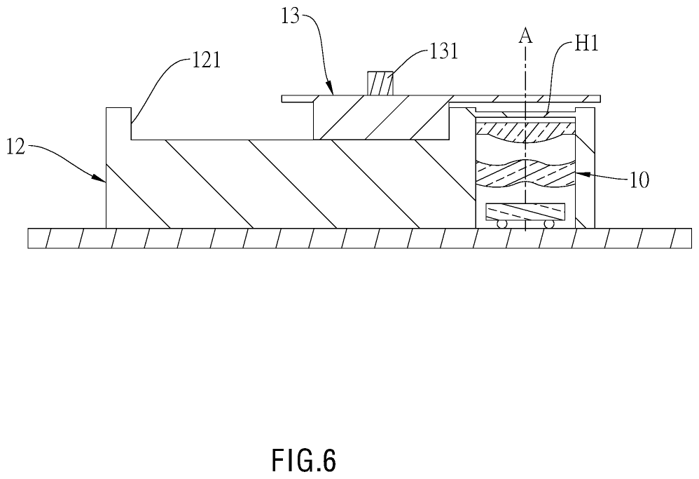

The cover mounting portion 12b has a guiding groove 121 accompany with the moving path, thereby the shading cover 13 could be stably disposed in the guiding groove 121 and could move along the guiding groove 121 to be hard to disengaged from the base 12. Additionally, a forced portion 131 could be provided on a side of the shading cover 13 opposite to the through-hole H1, thereby the forced portion 131 could be pushed to move on the moving path. For instance, referring to FIG. 5, the forced portion 131 could be a recess recessed into a surface of the shading cover 13 opposite to the base 12, so that a user could put a finger into the recess to push the shading cover 13 to move on the moving path; alternatively, referring to FIG. 6, the forced portion 131 could be a projection protruding from a surface of the shading cover 13 opposite to the base 12 towards a direction away from the base 12, so that a user could move the shading cover 13 by pushing the projection, allowing the optical image capturing system 10 to easily switch between the open state and the closed state.

In an embodiment of the present invention, the adjustable shading module 1 includes at least one driving device for driving the at least one shading cover to move on the moving path relative to the optical lens assembly 101, and the base has a driver mounting portion that is integrally formed with the optical mounting portion and the cover mounting portion. The driver mounting portion has at least one receiving space. The at least one driving device is disposed in the at least one receiving space. The at least one receiving space is adjacent to the chamber, wherein the at least one receiving space and the chamber are arranged along a reference axis not parallel to the optical axis A.

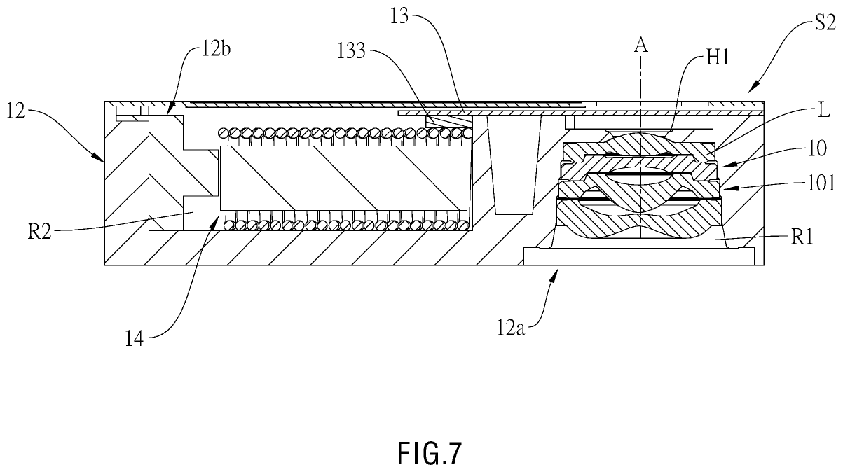

Referring to FIG. 7, in an embodiment, the number of the at least one driving device is one as an example, and the number of the at least one receiving space is one as an example, and the reference axis X is perpendicular to the optical axis A as an example. The driving device includes an electromagnet 14 disposed in the receiving space R2, and the shading cover 13 includes a magnetic member 133, which is a magnet as an example, connected to a side of the shading cover 13 facing towards the receiving space R2, so that the electromagnet 14 generates a magnetic field based on a received current to repel or attract the magnetic member 133, thereby driving the shading cover 13 to displace.

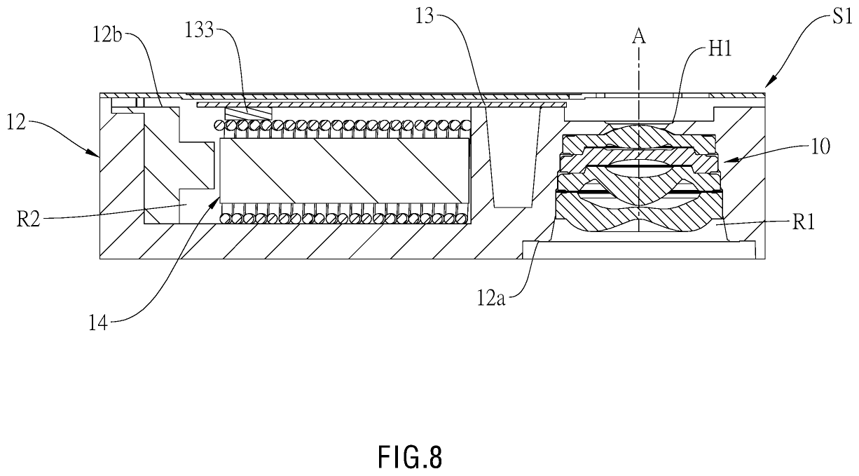

For instance, when the electromagnet 14 does not receive current, the shading cover 13 is in a position blocking ambient light from entering the optical image capturing system 10 through the through-hole H1 to make the optical image capturing system 10 be in the closed state S2, as shown in FIG. 7; while when the electromagnet 14 receives a first current and generates a magnetic field, the electromagnet attracts the magnetic member 133 to an end of the electromagnet 14, driving the shading cover 13 to move to a position allowing ambient light to enter the optical image capturing system 10 via the through-hole H1 to make the optical image capturing system 10 be in the open state S1, as shown in FIG. 8. Additionally, the optical image capturing system 10 could be switched from the open state S1 to the closed state S2 by providing the electromagnet 14 with a with a current opposite to the first current (i.e., opposite directions) to attract the magnetic member 133 to another end of the electromagnet 14, driving the shading cover 13 to move to the position shading the through-hole H1, and stopping provide current to keep the shading cover 13 at the position shading the through-hole H1.

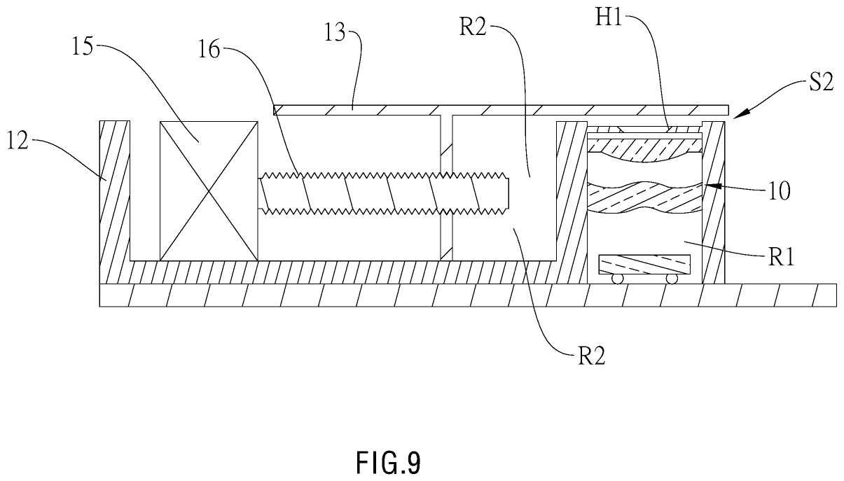

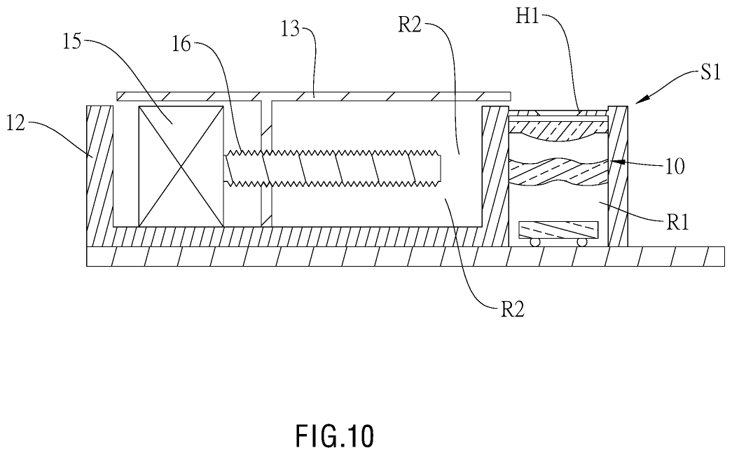

Referring to FIG. 9, in an embodiment, the number of the at least one driving device is one as an example, and the number of the at least one receiving space is one as an example. The driving device includes a motor 15 connected to the shading cover 13 to drive the shading cover 13 to move on the moving path relative to the optical lens assembly 101, wherein the motor 15 is connected to a threaded rod 16 and is disposed in the receiving space R2, and the shading cover 13 has a threaded section. The threaded rod 16 is connected to the shading cover 13 via the threaded section. The motor 15 could drive the threaded rod 16 to turn to drive the shading cover 13 to move between a position shown in FIG. 9 and a position shown in FIG. 10 to close or open the through-hole H1, allowing the optical image capturing system 10 to switch between the closed state S2 and the open state S1.

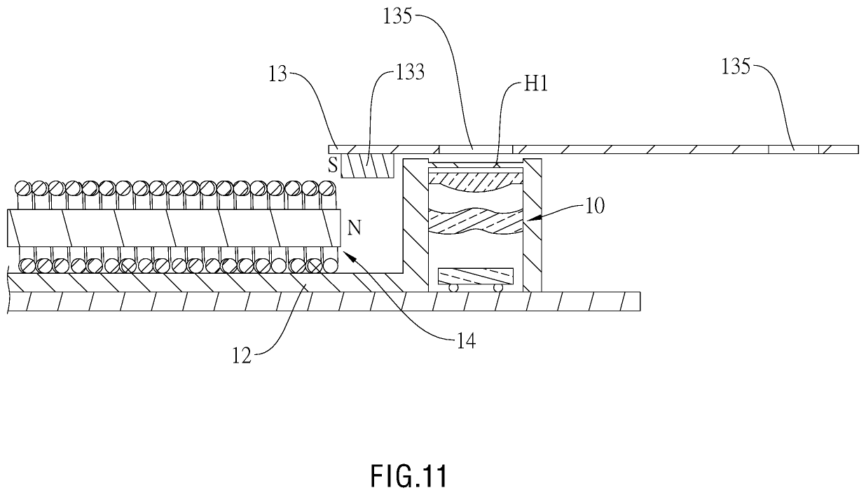

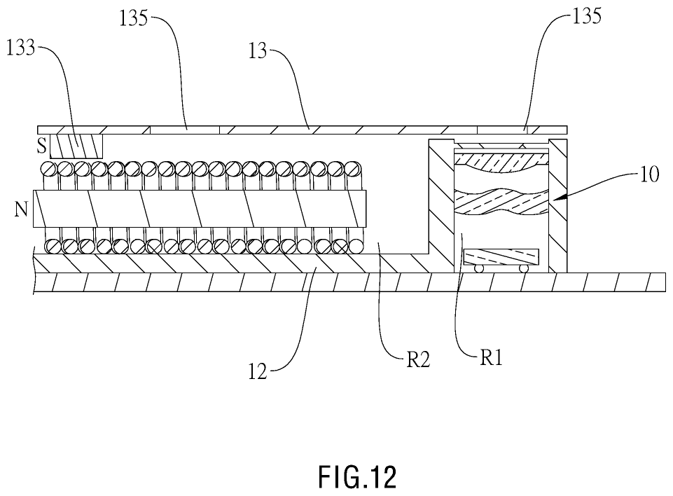

In an embodiment, the at least one shading cover has at least one light-transmitting hole, wherein the at least one shading cover could move along the moving path to a position that the at least one light-transmitting hole communicates with the through-hole H1 to open the through-hole H1 or to a position that the at least one light-transmitting hole does not communicate with the through-hole H1 to close the through-hole H1. In an embodiment, the at least one shading cover has a plurality of light-transmitting holes, wherein the light-transmitting holes respectively have different diameters and are arranged on the at least one shading cover along the moving path. For instance, referring to FIG. 11, two light-transmitting holes 135 with different diameters are disposed on the shading cover 13. When the electromagnet 14 receives a first current and generates a magnetic field to attract the magnetic member 133 to an end of the electromagnet 14 to move the shading cover 13 to a position shown in FIG. 11, one of the light-transmitting holes 135 with a larger diameter communicates with the through-hole H1, allowing ambient light to enter the optical image capturing system 10 through one of the light-transmitting holes 135 with a larger diameter; while when the electromagnet 14 receives a current opposite to the first current (i.e., opposite directions) and generates a magnetic field, the magnetic member 133 is attracted to another end of the electromagnet 14 to move the shading cover 13 to a position shown in FIG. 12, and one of the light-transmitting holes 135 with a smaller diameter communicates with the through-hole H1, allowing ambient light to enter the optical image capturing system 10 through one of the light-transmitting holes 135 with a smaller diameter. In this way, an effect of switching the amount of input light of the optical image capturing system 10 could be achieved.

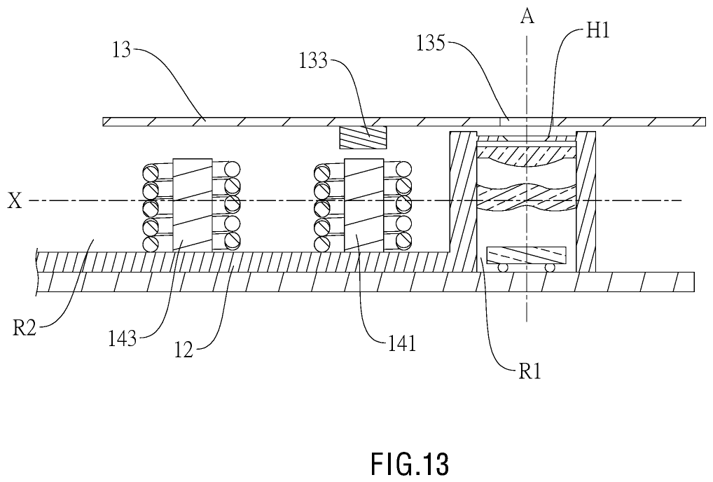

In an embodiment, the at least one driving device includes a plurality of electromagnets arranged along the reference axis X, wherein the electromagnets generate a magnetic field based on a received current to repel or attract the magnetic member 133, thereby to drive the shading cover 13 to displace. For instance, referring to FIG. 13, the driving device includes two electromagnets, which are respectively a first electromagnet 141 and a second electromagnet 143 arranged along the reference axis X. When the first electromagnet 141 receives a current and the second electromagnet 143 does not receive current, the first electromagnet 141 attracts the magnetic member 133 to move the shading cover 13 to a position that the light-transmitting hole 135 communicates with the through-hole H1, while when the first electromagnet 141 does not receive current and the second electromagnet 143 receives a current, the second electromagnet 143 attracts the magnetic member 133 to move the shading cover 13 to a position that the shading cover 13 shades the through-hole H1, thereby allowing the optical image capturing system 10 to be switched between the open state S1 and the closed state S2.

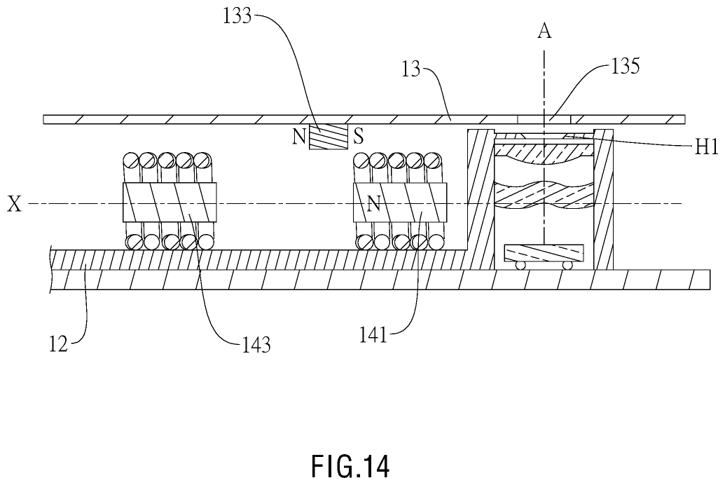

In the embodiment shown in FIG. 13, a direction of the magnetic field, which is generated by the first electromagnet 141 and the second electromagnet 143 after receiving a current, is substantially parallel to the optical axis A. In an embodiment shown in FIG. 14, the direction of the magnetic field, which is generated by the first electromagnet 141 and the second electromagnet 143 after receiving a current, could be substantially parallel to the reference axis X, which could allow the optical image capturing system 10 to switch between the open state S1 and the closed state S2 as well. For instance, when the first electromagnet 141 receives a current and the second electromagnet 143 does not receive current, the first electromagnet 141 attracts the magnetic member 133 to move the shading cover 13 to a position that the light-transmitting hole 135 communicates with the through-hole H1, while when the first electromagnet 141 does not receive current and the second electromagnet 143 receives a current, the second electromagnet 143 attracts the magnetic member 133 to move the shading cover 13 to a position that the shading cover 13 shades the through-hole H1.

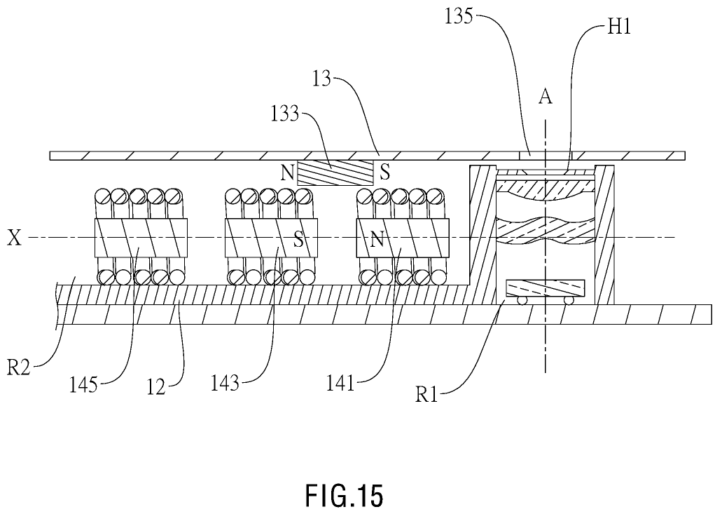

In an embodiment, the driving device could include more than two electromagnets. Referring to FIG. 15, the driving device includes three electromagnets arranged in order along the reference axis X, wherein the three electromagnets are respectively a first electromagnet 141, a second electromagnet 143, and a third electromagnet 145. A direction of the magnetic field, which is generated by the first electromagnet 141, the second electromagnet 143, and the third electromagnet 145 after receiving a current, is substantially parallel to the reference axis X. By controlling a current direction inputted to the first electromagnet 141 and the second electromagnet 143 or a coil winding direction, an end of the first electromagnet 141 facing the second electromagnet 143 and an end of the second electromagnet 143 facing the first electromagnet 141 generate opposite polarities when inputs current to the first electromagnet 141 and the second electromagnet 143, thereby respectively attracting two ends of the magnetic member 133 with opposite polarities. In this way, the magnetic member 133 could move to a position between the first electromagnet 141 and the second electromagnet 143 to move the shading cover 13 to a position that the light-transmitting hole 135 communicates with the through-hole 1. Similarly, by controlling a current direction inputted to the second electromagnet 143 and the third electromagnet 145 or a coil winding direction, an end of the second electromagnet 143 facing the third electromagnet 145 and an end of the third electromagnet 145 facing the second electromagnet 143 generate opposite polarities when inputs current to the second electromagnet 143 and the third electromagnet 145, thereby respectively attracting two ends of the magnetic member 133 with opposite polarities. In this way, the magnetic member 133 could be moved from the position between the first electromagnet 141 and the second electromagnet 143 to a position between the second electromagnet 143 and the third electromagnet 145, thereby moving the shading cover 13 to a position that the shading cover 13 shades the through-hole H1.

In an embodiment, the at least one driving device includes a first driving unit and a second driving unit, and the at least one shading cover includes a first shading cover and a second shading cover, wherein the first shading cover could be driven by the first driving unit to move on a first moving path to close or open the through-hole H1, and the second shading cover could be driven by the second driving unit to move on a second moving path to close or open the through-hole H1. The at least one receiving space includes a first receiving space and a second receiving space, wherein the chamber is located between the first receiving space and the second receiving space, and the first driving unit is received in the first receiving space, and the second driving unit is received in the second receiving space.

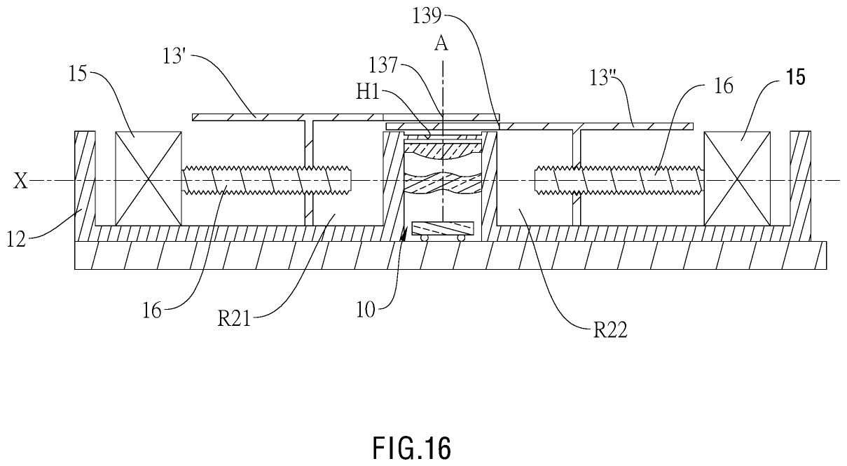

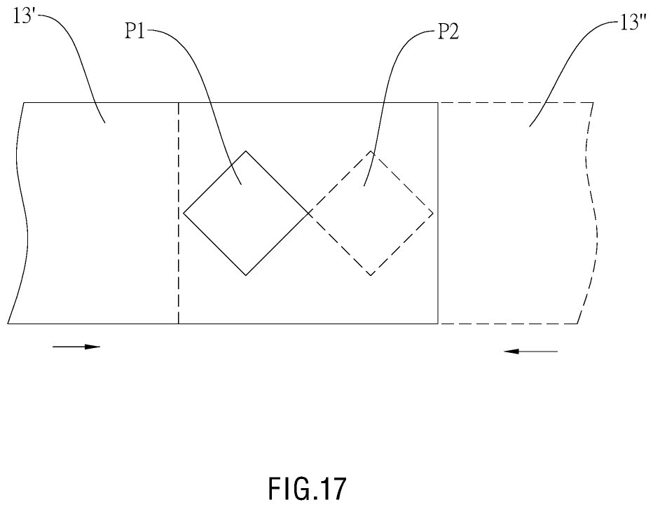

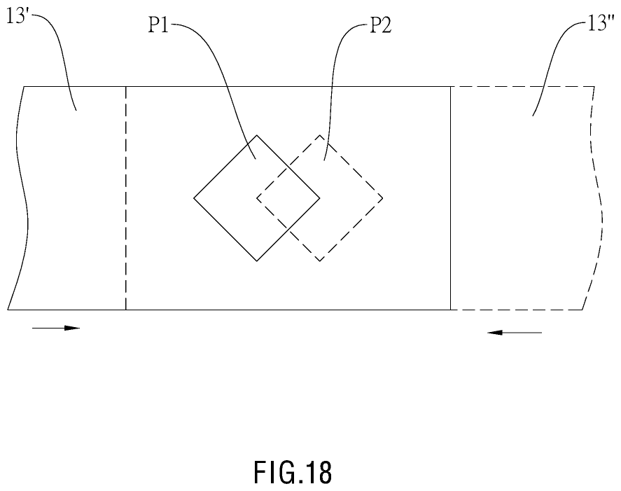

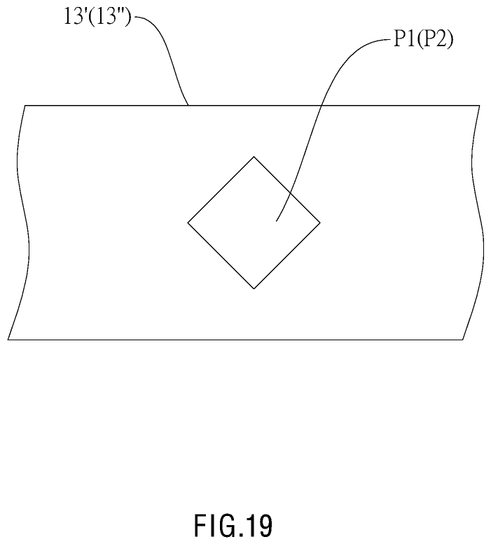

For instance, referring to FIG. 16, the first driving unit and the second driving unit respectively include a motor 15, wherein each of the motors 15 is correspondingly connected to the first shading cover 13′ and the second shading cover 13″ to correspondingly drive the first shading cover 13′ and the second shading cover 13″ to move on the moving path relative to the optical lens assembly 101. Each of the motors 15 is connected to a threaded rod 16. The motors 15 are respectively disposed in the first receiving space R21 and the second receiving space R22. The first shading cover 13′ and the second shading cover 13″ respectively have a threaded section and are respectively connected to one of the threaded rods 16 via the threaded sections. Each of the motors 15 could drive one of the threaded rods 16 to turn, thereby respectively drive the first shading cover 13′ and the first shading cover 13″ to move in between the positions shown in FIG. 17 to FIG. 19 to close, partially open, or open the through-hole H1, allowing the optical image capturing system 10 to switch in between the closed state S2, a partial-open state S3, and the open state S1.

Additionally, the first shading cover 13′ has a first light-transmitting hole 137, and the second shading cover 13″ has a second light-transmitting hole 139, wherein the first shading cover 13′ and the second shading cover 13″ could be respectively driven by the first driving unit and the second driving unit to move to a closed position, a partial-open position, and an open position. Referring to FIG. 17 to FIG. 19, the first light-transmitting hole 137 and the second light-transmitting hole 139 respectively have a first projection surface P1 and a second projection surface P2 on a reference surface perpendicular to the optical axis A. When the first shading cover 13′ and the second shading cover 13″ are located at the closed position, the first projection surface P1 does not overlap with the second projection surface P2. When the first shading cover 13′ and the second shading cover 13″ are located at the partial-open position, the first projection surface P1 partially overlaps with the second projection surface P2. When the first shading cover 13′ and the second shading cover 13″ are located at the open position, the first projection surface P1 and the second projection surface P2 completely overlap. In this way, the first shading cover 13′ and the second shading cover 13″ shade the through-hole H1 when the first shading cover 13′ and the second shading cover 13″ are located at the closed position, allowing the optical image capturing system 10 to be in the closed state S2; the first shading cover 13′ and the second shading cover 13″ shades a part of the through-hole H1 when the first shading cover 13′ and the second shading cover 13″ are located at the partial-open position, allowing the optical image capturing system 10 to be in the partial-open state S3; the first light-transmitting hole 137 of the first shading cover 13′ and the second light-transmitting hole 139 of the second shading cover 13″ completely communicate with the through-hole H1 when the first shading cover 13′ and the second shading cover 13″ are located at the open position, allowing the optical image capturing system 10 to be in the open state S1.

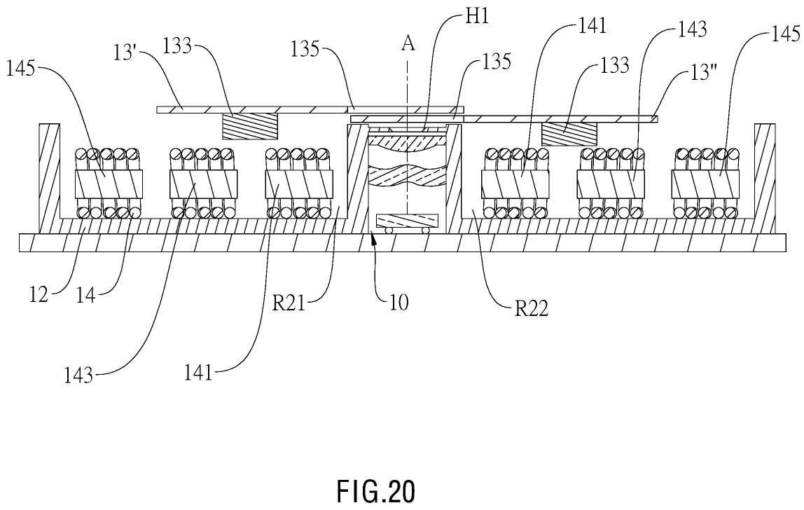

In the aforementioned embodiment, the first driving unit and the second driving unit respectively include a motor as an example, however, in other embodiments the first driving unit and the second driving unit could include a plurality of electromagnets 141, 143, 145 arranged along the reference axis X, as shown in FIG. 20, which could also drive the first shading cover 13′ and the first shading cover 13″ to move to close, partially open, or open the through-hole H1, allowing the optical image capturing system 10 to switch in between the closed state, the partial-open state S3, and the open state S1 as well.

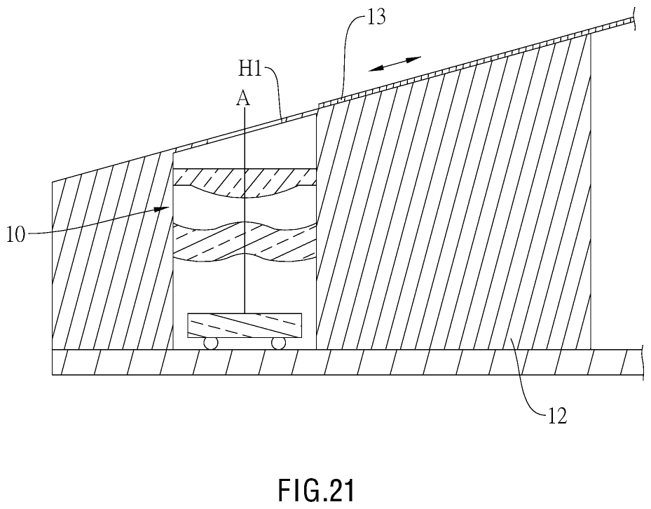

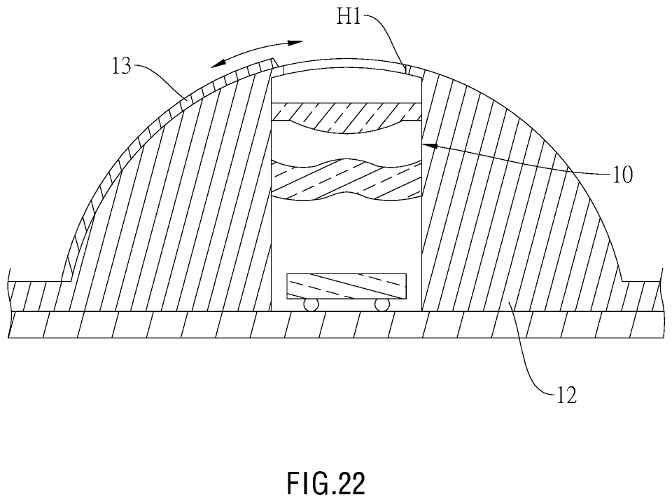

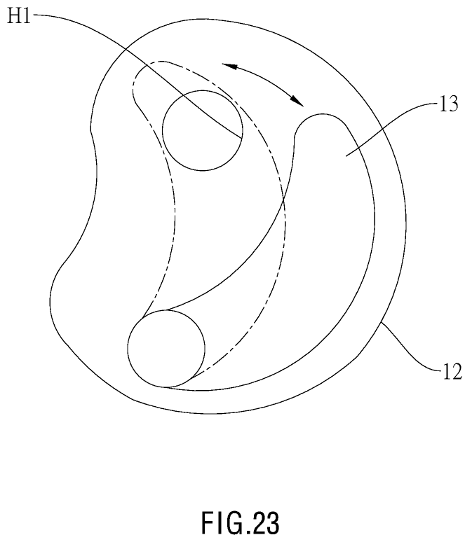

In the aforementioned embodiment, the moving path of the shading cover 13 is perpendicular to the optical axis A and is a straight line as an example. In practice, the moving path of the shading cover 13 could be not perpendicular to the optical axis A, as shown in FIG. 21 and FIG. 22. Alternatively, referring to FIG. 23, the shading cover 13 could be driven by a motor to swing or pivot, thereby allowing the moving path to be a curve.

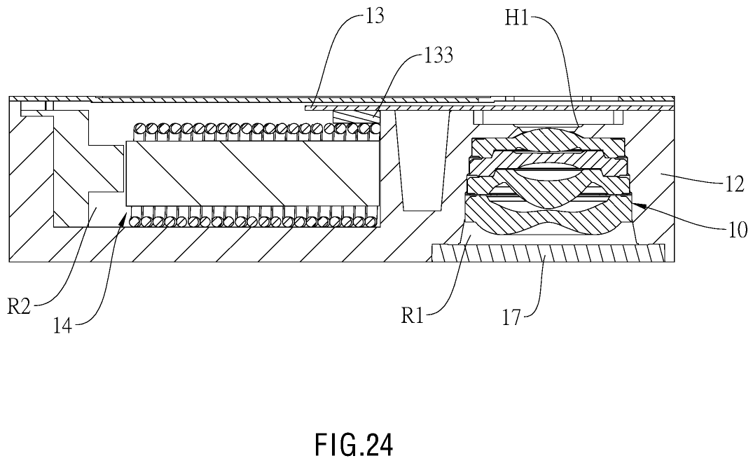

In an embodiment, referring to FIG. 24, the optical image capturing system 10 further includes an image sensor 17 and satisfies: 0.5≤HOS/f≤150 and 1.0≤f/HEP≤10.0, wherein a distance on the optical axis A between the image sensor 17 and an object-side surface of one of the lenses that is the closest to the object side of the optical lens assembly 101 is denoted by HOS; f is a focal length of the optical image capturing system 10; HEP is an entrance pupil diameter of the optical image capturing system 10.

The adjustable shading module 1 of the present invention could work in three wavelengths, including 486.1 nm, 587.5 nm, and 656.2 nm, wherein 587.5 nm is a main reference wavelength and is the reference wavelength for obtaining the technical characters. The adjustable shading module 1 of the present invention could also work in five wavelengths, including 470 nm, 510 nm, 555 nm, 610 nm, and 650 nm, wherein 555 nm is a main reference wavelength and is the reference wavelength for obtaining the technical characters.

The adjustable shading module of the present invention satisfies 0.5≤ΣPPR/|ΣNPR|≤15, and a preferable range is 1≤ΣPPR/|ΣNPR|≤3.0, wherein PPR is a ratio of a focal length f of the adjustable shading module to a focal length fp of each of lenses with positive refractive power; NPR is a ratio of the focal length f of the adjustable shading module to a focal length fn of each of lenses with negative refractive power; ΣPPR is a sum of the PPRs of each positive lens; and ΣNPR is a sum of the NPRs of each negative lens. It is helpful for control of an entire refractive power and an entire length of the adjustable shading module.

The adjustable shading module could further provide with an image sensor on an image plane of the adjustable shading module. The adjustable shading module of the present invention satisfies HOS/HOI≤50; and 0.5≤HOS/f≤150, and a preferable range is 1≤HOS/HOI≤40; and 1≤HOS/f≤140, wherein HOI is a half of a diagonal of an effective sensing area of the image sensor (i.e., a maximum image height of the adjustable shading module), and HOS is a distance on the optical axis between the object-side surface of the first lens and the image plane. It is helpful for reduction of the size of the adjustable shading module for used on thin and portable electronic products.

Additionally, the adjustable shading module of the present invention could further provide with an aperture to reduce stray light and improve image quality.

In the adjustable shading module of the present invention, the aperture could be a front aperture or a middle aperture, wherein the front aperture is provided between the object and the first lens, and the middle aperture is provided between the first lens and the image plane. The front aperture provides a longer distance between an exit pupil of the adjustable shading module and the image plane, which allows to receive more elements and increases an efficiency that the image sensor receives images. The middle aperture could enlarge a view angle of view of the adjustable shading module, thereby allowing the adjustable shading module has an advantage of a wide-angle lens. The adjustable shading module satisfies 0.1≤InS/HOS≤1.1, wherein InS is a distance between the aperture and the image plane. It is helpful for size reduction and wide angle.

The adjustable shading module of the present invention satisfies 0.1≤ΣTP/InTL≤0.9, wherein InTL is a distance between the object-side surface of the first lens and the image-side surface of the sixth lens, and ΣTP is a sum of central thicknesses of the lenses on the optical axis. It is helpful for the contrast of image and yield rate of manufacture and provides a suitable back focal length for installation of other elements.

The adjustable shading module of the present invention satisfies 0.001≤|R1/R2|≤25, and a preferable range is 0.01≤|R1/R2|<12, wherein R1 is a radius of curvature of the object-side surface of the first lens, and R2 is a radius of curvature of the image-side surface of the first lens. It provides the first lens with a suitable positive refractive power to reduce the increase rate of the spherical aberration.

The adjustable shading module of the present invention satisfies −7<(R11−R12)/(R11+R12)<50, wherein R11 is a radius of curvature of the object-side surface of the sixth lens, and R12 is a radius of curvature of the image-side surface of the sixth lens. It may modify the astigmatic field curvature.

The adjustable shading module of the present invention satisfies IN12/f≤60, wherein IN12 is a distance on the optical axis between the first lens and the second lens. It may correct chromatic aberration and improve the performance.

The adjustable shading module of the present invention satisfies IN56/f≤3.0, wherein IN56 is a distance on the optical axis between the fifth lens and the sixth lens. It may correct chromatic aberration and improve the performance.

The adjustable shading module of the present invention satisfies 0.1≤(TP1+IN12)/TP2≤10, wherein TP1 is a central thickness of the first lens on the optical axis, and TP2 is a central thickness of the second lens on the optical axis. It may control the sensitivity of manufacture of the adjustable shading module and improve the performance.

The adjustable shading module of the present invention satisfies 0.1≤(TP6+IN56)/TP5≤15, wherein TP5 is a central thickness of the fifth lens on the optical axis, TP6 is a central thickness of the sixth lens on the optical axis, and IN56 is a distance between the fifth lens and the sixth lens. It may control the sensitivity of manufacture of the adjustable shading module and reduce a total height thereof

The adjustable shading module of the present invention satisfies 0.1≤TP4/(IN34+TP4+IN45)<1, wherein TP4 is a central thickness of the fourth lens on the optical axis, IN34 is a distance on the optical axis between the third lens and the fourth lens, IN45 is a distance on the optical axis between the fourth lens and the fifth lens. It may fine tune and correct the aberration of the incident rays layer by layer, and reduce the height of the adjustable shading module.

The adjustable shading module satisfies 0 mm≤HVT61≤3 mm; 0 mm<HVT62≤6 mm; 0≤HVT61/HVT62; 0 mm≤|SGC61|≤0.5 mm; 0 mm<|SGC62|≤2 mm; and 0<|SGC62|/(|SGC62|+TP6)≤0.9, wherein HVT61 is a distance perpendicular to the optical axis between the critical point C61 on the object-side surface of the sixth lens and the optical axis; HVT62 is a distance perpendicular to the optical axis between the critical point C62 on the image-side surface of the sixth lens and the optical axis; SGC61 is a distance on the optical axis between a point on the object-side surface of the sixth lens where the optical axis passes through and a point where the critical point C61 projects on the optical axis; SGC62 is a distance on the optical axis between a point on the image-side surface of the sixth lens where the optical axis passes through and a point where the critical point C62 projects on the optical axis. It is helpful to correct the off-axis view field aberration.

The adjustable shading module satisfies 0.2≤HVT62/HOI≤0.9, and preferably satisfies 0.3≤HVT62/HOI≤0.8. It may help to correct the peripheral aberration around the adjustable shading module.

The adjustable shading module satisfies 0≤HVT62/HOS≤0.5, and preferably satisfies 0.2≤HVT62/HOS≤0.45. It may help to correct the peripheral aberration around the adjustable shading module.

The adjustable shading module of the present invention satisfies 0<SGI611/(SGI611+TP6)≤0.9; 0<SGI621/(SGI621+TP6)≤0.9, and it is preferable to satisfy 0.1≤SGI611/(SGI611+TP6)≤0.6; 0.1≤SGI621/(SGI621+TP6)≤0.6, wherein SGI611 is a displacement on the optical axis from a point on the object-side surface of the sixth lens, through which the optical axis passes, to a point where the inflection point on the object-side surface of the sixth lens, which is the closest to the optical axis, projects on the optical axis; SGI621 is a displacement on the optical axis from a point on the image-side surface of the sixth lens, through which the optical axis passes, to a point where the inflection point on the image-side surface of the sixth lens, which is the closest to the optical axis, projects on the optical axis.

The adjustable shading module of the present invention satisfies 0<SGI612/(SGI612+TP6)≤0.9; 0<SGI622/(SGI622+TP6)≤0.9, and it is preferable to satisfy 0.1≤SGI612 /(SGI612+TP6)≤0.6; 0.1≤SGI622/(SGI622+TP6)≤0.6, wherein SGI612 is a displacement on the optical axis from a point on the object-side surface of the sixth lens, through which the optical axis passes, to a point where the inflection point on the object-side surface of the sixth lens, which is the second closest to the optical axis, projects on the optical axis, and SGI622 is a displacement on the optical axis from a point on the image-side surface of the sixth lens, through which the optical axis passes, to a point where the inflection point on the image-side surface of the sixth lens, which is the second closest to the optical axis, projects on the optical axis.

The adjustable shading module of the present invention satisfies 0.001 mm≤|HIF611|≤5 mm; 0.001 mm≤|HIF621|≤5 mm, and it is preferable to satisfy 0.1 mm≤|HIF611|≤3.5 mm; 1.5 mm≤|HIF621|≤3.5 mm, wherein HIF611 is a distance perpendicular to the optical axis between the optical axis and the inflection point on the object-side surface of the sixth lens, which is the closest to the optical axis; HIF621 is a distance perpendicular to the optical axis between the optical axis and the inflection point on the image-side surface of the sixth lens, which is the closest to the optical axis.

The adjustable shading module of the present invention satisfies 0.001 mm≤|HIF612|≤5 mm; 0.001 mm≤|HIF622|≤5 mm, and it is preferable to satisfy 0.1 mm≤|HIF622|≤3.5 mm; 0.1 mm≤|HIF612|≤3.5 mm, wherein HIF612 is a distance perpendicular to the optical axis between the optical axis and the inflection point on the object-side surface of the sixth lens, which is the second closest to the optical axis; HIF622 is a distance perpendicular to the optical axis between the optical axis and the inflection point on the image-side surface of the sixth lens, which is the second closest to the optical axis.

The adjustable shading module of the present invention satisfies 0.001 mm≤|HIF613|≤5 mm; 0.001 mm≤|HIF623|≤5 mm, and it is preferable to satisfy 0.1 mm≤|HIF623|≤3.5 mm; 0.1 mm≤|HIF613|≤3.5 mm, wherein HIF613 is a distance perpendicular to the optical axis between the optical axis and the inflection point on the object-side surface of the sixth lens, which is the third closest to the optical axis; HIF723 is a distance perpendicular to the optical axis between the optical axis and the inflection point on the image-side surface of the sixth lens, which is the third closest to the optical axis.

The adjustable shading module of the present invention satisfies 0.001 mm≤|HIF614|≤5 mm; 0.001 mm≤|HIF624|≤5 mm, and it is preferable to satisfy 0.1 mm≤|HIF624|≤3.5 mm; 0.1 mm≤|HIF614|≤3.5 mm, wherein HIF614 is a distance perpendicular to the optical axis between the optical axis and the inflection point on the object-side surface of the sixth lens, which is the fourth closest to the optical axis; HIF624 is a distance perpendicular to the optical axis between the optical axis and the inflection point on the image-side surface of the sixth lens, which is the fourth closest to the optical axis.

The adjustable shading module of the present invention satisfies: 0mm<PhiA≤17.4 mm, and a preferable range is 0 mm<PhiA≤13.5 mm; 0 mm<PhiC≤17.7 mm, and a preferable range is 0 mm<PhiC≤14 mm; 0 mm<PhiD≤18 mm, and a preferable range is 0 mm<PhiD≤15 mm; 0 mm<TH1≤5 mm, and a preferable range is 0 mm<TH1≤0.5 mm; 0 mm<TH2≤5 mm, and a preferable range is 0 mm<TH2≤0.5 mm; 0<PhiA/PhiD≤0.99, and a preferable range is 0<PhiA/PhiD≤0.97; 0 mm<TH1+TH2≤10 mm, and a preferable range is 0 mm<TH1+TH2≤1.5 mm; 0<(TH1+TH2)/HOI≤0.95, and a preferable range is 0<(TH1+TH2)/HOI≤0.5; 0<(TH1+TH2)/HOS≤0.95, and a preferable range is 0<(TH1+TH2)/HOS≤0.5; 0<(TH1+TH2)/PhiA≤0.95, and a preferable range is 0<(TH1+TH2)/ PhiA≤0.5.

In an embodiment, the lenses of high Abbe number and the lenses of low Abbe number are arranged in an interlaced arrangement that could be helpful for correction of aberration of the adjustable shading module.

An equation of aspheric surface is

z=ch²/[1+[1−(k+1)c²h²]^{0.5}]+A4h⁴+A6h⁶+A8h⁸+A10h¹⁰+A12h¹²+A14h¹⁴+A16h¹⁶+A18h¹⁸+A20h²⁰+ . . . (1)

wherein z is a depression of the aspheric surface; k is conic constant; c is reciprocal of the radius of curvature; and A4, A6, A8, A10, Al2, A14, A16, A18, and A20 are high-order aspheric coefficients.

In the adjustable shading module, the lenses could be made of plastic or glass. The plastic lenses may reduce the weight and lower the cost of the adjustable shading module, and the glass lenses may control the thermal effect and enlarge the space for arrangement of the refractive power of the adjustable shading module. In addition, the opposite surfaces (object-side surface and image-side surface) of the first to the seventh lenses could be aspheric that can obtain more control parameters to reduce aberration. The number of aspheric glass lenses could be less than the conventional spherical glass lenses, which is helpful for reduction of the height of the adjustable shading module.

In the present invention, when it comes to the lens has a convex surface, it means that the surface is convex around a position, through which the optical axis passes, and when it comes to the lens has a concave surface, it means that the surface is concave around a position, through which the optical axis passes.

The adjustable shading module of the present invention could be applied in a dynamic focusing optical system. It is superior in the correction of aberration and high imaging quality so that it could be allied in lots of fields.

The adjustable shading module of the present invention could further include a driving module to meet different demands, wherein the driving module could be coupled with the lenses to move the lenses. The driving module could be a voice coil motor (VCM), which is used to move the lens for focusing, or could be an optical image stabilization (OIS) component, which is used to lower the possibility of having the problem of image blurring which is caused by subtle movements of the lens while shooting.

To meet different requirements, at least one lens among the first lens to the seventh lens of the adjustable shading module of the present invention could be a light filter, which filters out light of wavelength shorter than 500nm. Such effect could be achieved by coating on at least one surface of the lens, or by using materials capable of filtering out short waves to make the lens.

To meet different requirements, the image plane of the adjustable shading module in the present invention could be either flat or curved. If the image plane is curved (e.g., a sphere with a radius of curvature), the incidence angle required for focusing light on the image plane could be decreased, which is not only helpful to shorten the length of the adjustable shading module (TTL), but also helpful to increase the relative illuminance.

Several optical embodiments are provided in conjunction with the accompanying drawings for the best understanding, which are:

### First Optical Embodiment

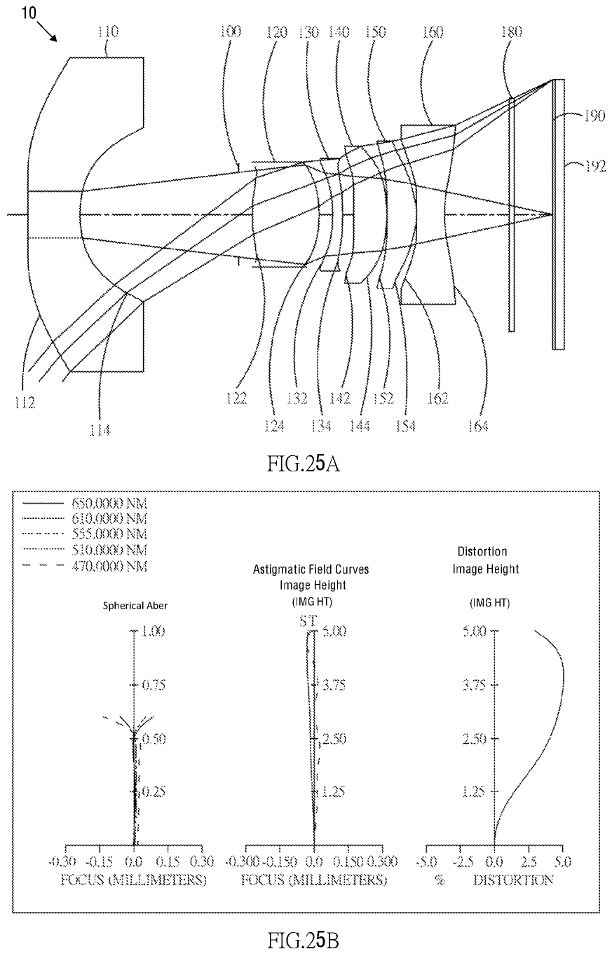

Referring to FIG. 25A, a schematic diagram of an optical image capturing system 10 according to a first optical embodiment of the present invention. Referring to FIG. 25B, curve diagrams of longitudinal spherical aberration, astigmatic field curves, and distortion in order from left to right according to the first optical embodiment of the present invention.

As shown in FIG. 25A, the optical image capturing system 10 of the first optical embodiment of the present invention includes, along an optical axis from an object side to an image side, a first lens 110, an aperture 100, a second lens 120, a third lens 130, a fourth lens 140, a fifth lens 150, a sixth lens 160, an infrared rays filter 180, an image plane 190, and an image sensor 192.

The first lens 110 has negative refractive power and is made of plastic. An object-side surface 112 thereof, which faces the object side, is a concave aspheric surface, and an image-side surface 114 thereof, which faces the image side, is a concave aspheric surface. The object-side surface 112 has two inflection points. A profile curve length of a maximum effective half diameter of the object-side surface 112 of the first lens 110 is denoted by ARS11, and a profile curve length of a maximum effective half diameter of the image-side surface 114 of the first lens 110 is denoted by ARS12. A profile curve length of a half of an entrance pupil diameter (HEP) of the object-side 112 surface of the first lens 110 is denoted by ARE11, and a profile curve length of a half of the entrance pupil diameter (HEP) of the image-side surface 114 of the first lens 110 is denoted by ARE12. A thickness of the first lens 110 on the optical axis is denoted by TP1.

The first lens 110 satisfies: SGI111=−0.0031 mm; |SGI111|/(|SGI111|+TP1)=0.0016, wherein a displacement on the optical axis from a point on the object-side surface 112 of the first lens 110, through which the optical axis passes, to a point where the inflection point on the object-side surface 112, which is the closest to the optical axis, projects on the optical axis, is denoted by SGI111, and a displacement on the optical axis from a point on the image-side surface 114 of the first lens 110, through which the optical axis passes, to a point where the inflection point on the image-side surface, which is the closest to the optical axis, projects on the optical axis is denoted by SGI121.

The first lens 110 satisfies SGI112=1.3178 mm; |SGI112|/(|SGI112|+TP1)=0.4052, wherein a displacement on the optical axis from a point on the object-side surface 112 of the first lens 110, through which the optical axis passes, to a point where the inflection point on the object-side surface 112, which is the second closest to the optical axis, projects on the optical axis, is denoted by SGI112, and a displacement on the optical axis from a point on the image-side surface 114 of the first lens 110, through which the optical axis passes, to a point where the inflection point on the image-side surface, which is the second closest to the optical axis, projects on the optical axis is denoted by SGI122.

The first lens 110 satisfies: HIF111=0.5557 mm; HIF111/HOI=0.1111; wherein a displacement perpendicular to the optical axis from the inflection point on the object-side surface 112 of the first lens 110, which is the closest to the optical axis is denoted by HIF111, and a displacement perpendicular to the optical axis from the inflection point on the image-side surface 114 of the first lens 110, which is the closest to the optical axis is denoted by HIF121.

The first lens 110 satisfies: HIF112=5.3732 mm; HIF112/HOI=1.0746; wherein a displacement perpendicular to the optical axis from the inflection point on the object-side surface 112 of the first lens 110, which is the second closest to the optical axis is denoted by HIF112, and a displacement perpendicular to the optical axis from the inflection point on the image-side surface 114 of the first lens 110, which is the second closest to the optical axis is denoted by HIF122.

The second lens 120 has positive refractive power and is made of plastic. An object-side surface 122 thereof, which faces the object side, is a convex aspheric surface, and an image-side surface 124 thereof, which faces the image side, is a convex aspheric surface. The object-side surface 122 has an inflection point. A profile curve length of a maximum effective half diameter of the object-side surface 122 of the second lens 120 is denoted by ARS21, and a profile curve length of a maximum effective half diameter of the image-side surface 124 of the second lens 120 is denoted by ARS22. A profile curve length of a half of an entrance pupil diameter (HEP) of the object-side surface 122 of the second lens 120 is denoted by ARE21, and a profile curve length of a half of the entrance pupil diameter (HEP) of the image-side surface 124 of the second lens 120 is denoted by ARS22. A thickness of the second lens 120 on the optical axis is denoted by TP2.

The second lens 120 satisfies: SGI211=0.1069 mm; |SGI211|/(|SGI211|+TP2)=0.0412; SGI221=0 mm; |SGI221|/(|SGI221|+TP2)=0; wherein a displacement on the optical axis from a point on the object-side surface 122 of the second lens 120, through which the optical axis passes, to a point where the inflection point on the object-side surface 122, which is the closest to the optical axis, projects on the optical axis, is denoted by SGI211, and a displacement on the optical axis from a point on the image-side surface 124 of the second lens 120, through which the optical axis passes, to a point where the inflection point on the image-side surface 124, which is the closest to the optical axis, projects on the optical axis is denoted by SGI221.

The second lens 120 satisfies: HIF211=1.1264 mm; HIF211/HOI=0.2253; HIF221=0 mm; HIF221/HOI=0; wherein a displacement perpendicular to the optical axis from the inflection point on the object-side surface 122 of the second lens 120, which is the closest to the optical axis is denoted by HIF211, and a displacement perpendicular to the optical axis from the inflection point on the image-side surface 124 of the second lens 120, which is the closest to the optical axis is denoted by HIF221.

The third lens 130 has negative refractive power and is made of plastic. An object-side surface 132, which faces the object side, is a concave aspheric surface, and an image-side surface 134, which faces the image side, is a convex aspheric surface. The object-side surface 132 has an inflection point, and the image-side surface 134 has an inflection point. A profile curve length of a maximum effective half diameter of the object-side surface 132 of the third lens 130 is denoted by ARS31, and a profile curve length of a maximum effective half diameter of the image-side surface 134 of the third lens 130 is denoted by ARS32. A profile curve length of a half of an entrance pupil diameter (HEP) of the object-side surface 132 of the third lens 130 is denoted by ARE31, and a profile curve length of a half of the entrance pupil diameter (HEP) of the image-side surface 134 of the third lens 130 is denoted by ARS32. A thickness of the third lens 130 on the optical axis is denoted by TP3.

The third lens 130 satisfies: SGI311=−0.3041 mm; |SGI311|/(|SGI311|+TP3)=0.4445; SGI321=−0.1172 mm; |SGI321|/(|SGI321|+TP3)=0.2357; wherein SGI311 is a displacement on the optical axis from a point on the object-side surface 132 of the third lens 130, through which the optical axis passes, to a point where the inflection point on the object-side surface 132, which is the closest to the optical axis, projects on the optical axis, and SGI321 is a displacement on the optical axis from a point on the image-side surface 134 of the third lens 130, through which the optical axis passes, to a point where the inflection point on the image-side surface 134, which is the closest to the optical axis, projects on the optical axis.

The third lens 130 satisfies: HIF311=1.5907 mm; HIF311/HOI=0.3181; HIF321=1.3380 mm; HIF321/HOI=0.2676; wherein HIF311 is a distance perpendicular to the optical axis between the optical axis and the inflection point on the object-side surface 132 of the third lens 130, which is the closest to the optical axis; HIF321 is a distance perpendicular to the optical axis between the optical axis and the inflection point on the image-side surface 134 of the third lens 130, which is the closest to the optical axis.

The fourth lens 140 has positive refractive power and is made of plastic. An object-side surface 142, which faces the object side, is a convex aspheric surface, and an image-side surface 144, which faces the image side, is a concave aspheric surface. The object-side surface 142 has two inflection points, and the image-side surface 144 has an inflection point. A profile curve length of a maximum effective half diameter of the object-side surface 142 of the fourth lens 140 is denoted by ARS41, and a profile curve length of a maximum effective half diameter of the image-side surface 144 of the fourth lens 140 is denoted by ARS42. A profile curve length of a half of an entrance pupil diameter (HEP) of the object-side surface 142 of the fourth lens 140 is denoted by ARE41, and a profile curve length of a half of the entrance pupil diameter (HEP) of the image-side surface 144 of the fourth lens 140 is denoted by ARS42. A thickness of the fourth lens 140 on the optical axis is denoted by TP4.

The fourth lens 140 satisfies: SGI411=0.0070 mm; |SGI411|/(|SGI411|+TP4)=0.0056; SGI421=0.0006 mm; |SGI421|/(|SGI421|+TP4)=0.0005; wherein SGI411 is a displacement on the optical axis from a point on the object-side surface 142 of the fourth lens 140, through which the optical axis passes, to a point where the inflection point on the object-side surface 142, which is the closest to the optical axis, projects on the optical axis, and SGI421 is a displacement on the optical axis from a point on the image-side surface 144 of the fourth lens 140, through which the optical axis passes, to a point where the inflection point on the image-side surface 144, which is the closest to the optical axis, projects on the optical axis.

The fourth lens 140 satisfies: SGI412=−0.2078 mm; |SGI412|/(|SGI412|+TP4)=0.1439; wherein SGI412 is a displacement on the optical axis from a point on the object-side surface 142 of the fourth lens 140, through which the optical axis passes, to a point where the inflection point on the object-side surface 142, which is the second closest to the optical axis, projects on the optical axis, and SGI422 is a displacement on the optical axis from a point on the image-side surface 144 of the fourth lens 140, through which the optical axis passes, to a point where the inflection point on the image-side surface 144, which is the second closest to the optical axis, projects on the optical axis.

The fourth lens 140 further satisfies: HIF411=0.4706 mm; HIF411/HOI=0.0941; HIF421=0.1721 mm; HIF421/HOI=0.0344; wherein HIF411 is a distance perpendicular to the optical axis between the optical axis and the inflection point on the object-side surface 142 of the fourth lens 140, which is the closest to the optical axis; HIF421 is a distance perpendicular to the optical axis between the optical axis and the inflection point on the image-side surface 144 of the fourth lens 140, which is the closest to the optical axis.

The fourth lens 140 satisfies: HIF412=2.0421 mm; HIF412/HOI=0.4084; wherein HIF412 is a distance perpendicular to the optical axis between the optical axis and the inflection point on the object-side surface 142 of the fourth lens 140, which is the second closest to the optical axis; HIF422 is a distance perpendicular to the optical axis between the optical axis and the inflection point on the image-side surface 144 of the fourth lens 140, which is the second closest to the optical axis.

The fifth lens 150 has positive refractive power and is made of plastic. An object-side surface 152, which faces the object side, is a convex aspheric surface, and an image-side surface 154, which faces the image side, is a convex aspheric surface. The object-side surface 152 has two inflection points, and the image-side surface 154 has an inflection point. A profile curve length of a maximum effective half diameter of the object-side surface 152 of the fifth lens 150 is denoted by ARS51, and a profile curve length of a maximum effective half diameter of the image-side surface 154 of the fifth lens 150 is denoted by ARS52. A profile curve length of a half of an entrance pupil diameter (HEP) of the object-side surface 152 of the fifth lens 150 is denoted by ARE51, and a profile curve length of a half of the entrance pupil diameter (HEP) of the image-side surface 154 of the fifth lens 150 is denoted by ARE52. A thickness of the fifth lens 150 on the optical axis is denoted by TP5.

The fifth lens 150 satisfies: SGI511=0.00364 mm; |SGI511|/(|SGI511|+TP5)=0.00338; SGI521=−0.63365 mm; |SGI521|/(|SGI521|+TP5)=0.37154; wherein SGI511 is a displacement on the optical axis from a point on the object-side surface 152 of the fifth lens 150, through which the optical axis passes, to a point where the inflection point on the object-side surface 152, which is the closest to the optical axis, projects on the optical axis, and SGI521 is a displacement on the optical axis from a point on the image-side surface 154 of the fifth lens 150, through which the optical axis passes, to a point where the inflection point on the image-side surface 154, which is the closest to the optical axis, projects on the optical axis.

The fifth lens 150 satisfies: SGI512=−0.32032 mm; |SGI512|/(|SGI512|+TP5)=0.23009; wherein SGI512 is a displacement on the optical axis from a point on the object-side surface 152 of the fifth lens 150, through which the optical axis passes, to a point where the inflection point on the object-side surface 152, which is the second closest to the optical axis, projects on the optical axis, and SGI522 is a displacement on the optical axis from a point on the image-side surface 154 of the fifth lens 150, through which the optical axis passes, to a point where the inflection point on the object-side surface, which is the second closest to the optical axis, projects on the optical axis.

The fifth lens 150 further satisfies: SGI513=0 mm; |SGI513|(|SGI513|+TP5)=0; SGI523=0 mm; |SGI523|/(|SGI523|+TP5)=0; wherein SGI513 is a displacement on the optical axis from a point on the object-side surface 152 of the fifth lens 150, through which the optical axis passes, to a point where the inflection point on the object-side surface 152, which is the third closest to the optical axis, projects on the optical axis, and SGI523 is a displacement on the optical axis from a point on the image-side surface 154 of the fifth lens 150, through which the optical axis passes, to a point where the inflection point on the object-side surface, which is the third closest to the optical axis, projects on the optical axis.

The fifth lens 150 further satisfies: SGI514=0 mm; |SGI514|(|SGI514|+TP5)=0; SGI524=0 mm; |SGI524|/(SGI524|+TP5)=0; wherein SGI514 is a displacement on the optical axis from a point on the object-side surface 152 of the fifth lens 150, through which the optical axis passes, to a point where the inflection point on the object-side surface 152, which is the fourth closest to the optical axis, projects on the optical axis, and SGI524 is a displacement on the optical axis from a point on the image-side surface 154 of the fifth lens 150, through which the optical axis passes, to a point where the inflection point on the object-side surface, which is the fourth closest to the optical axis, projects on the optical axis.

The fifth lens 150 satisfies: HIF511=0.28212 mm; HIF511/HOI=0.05642; HIF521=2.13850 mm; HIF521/HOI=0.42770; wherein HIF511 is a distance perpendicular to the optical axis between the optical axis and the inflection point on the object-side surface 152 of the fifth lens 150, which is the closest to the optical axis; HIF521 is a distance perpendicular to the optical axis between the optical axis and the inflection point on the image-side surface 154 of the fifth lens 150, which is the closest to the optical axis.

The fifth lens 150 satisfies: HIF512=2.51384 mm; HIF512/HOI=0.50277; wherein HIF512 is a distance perpendicular to the optical axis between the optical axis and the inflection point on the object-side surface 152 of the fifth lens 150, which is the second closest to the optical axis; HIF522 is a distance perpendicular to the optical axis between the optical axis and the inflection point on the image-side surface 154 of the fifth lens 150, which is the second closest to the optical axis.

The fifth lens 150 satisfies: HIF513=0 mm; HIF513/HOI=0; HIF523=0 mm; HIF523/HOI=0; wherein HIF513 is a distance perpendicular to the optical axis between the optical axis and the inflection point on the object-side surface 152 of the fifth lens 150, which is the third closest to the optical axis; HIF523 is a distance perpendicular to the optical axis between the optical axis and the inflection point on the image-side surface 154 of the fifth lens 150, which is the third closest to the optical axis.

The fifth lens 150 satisfies: HIF514=0 mm; HIF514/HOI=0; HIF524=0 mm; HIF524/HOI=0; wherein HIF514 is a distance perpendicular to the optical axis between the optical axis and the inflection point on the object-side surface 152 of the fifth lens 150, which is the fourth closest to the optical axis; HIF524 is a distance perpendicular to the optical axis between the optical axis and the inflection point on the image-side surface 154 of the fifth lens 150, which is the fourth closest to the optical axis.

The sixth lens 160 has negative refractive power and is made of plastic. An object-side surface 162, which faces the object side, is a concave surface, and an image-side surface 164, which faces the image side, is a concave surface. The object-side surface 162 has two inflection points, and the image-side surface 164 has an inflection point. Whereby, incident angle of each field of view for the sixth lens could be effectively adjusted to improve aberration. A profile curve length of a maximum effective half diameter of the object-side surface 162 of the sixth lens 160 is denoted by ARS61, and a profile curve length of a maximum effective half diameter of the image-side surface 164 of the sixth lens 160 is denoted by ARS62. A profile curve length of a half of an entrance pupil diameter (HEP) of the object-side surface 162 of the sixth lens 160 is denoted by ARE61, and a profile curve length of a half of the entrance pupil diameter (HEP) of the image-side surface 164 of the sixth lens 160 is denoted by ARE62. A thickness of the sixth lens 160 on the optical axis is denoted by TP6.

The sixth lens 160 satisfies: SGI611=−0.38558 mm; |SGI611|/(|SGI611|+TP6)=0.27212; SGI621=0.12386 mm; |SGI621|/(|SGI621|+TP6)=0.10722; wherein SGI611 is a displacement on the optical axis from a point on the object-side surface 162 of the sixth lens 160, through which the optical axis passes, to a point where the inflection point on the object-side surface 162, which is the closest to the optical axis, projects on the optical axis, and SGI621 is a displacement on the optical axis from a point on the image-side surface 164 of the sixth lens 160, through which the optical axis passes, to a point where the inflection point on the image-side surface 164, which is the closest to the optical axis, projects on the optical axis.

The sixth lens 160 further satisfies: SGI612=−0.47400 mm; |SGI612|/(|SGI612|+TP6)=0.31488; SG1622=0 mm; |SGI622|/(|SGI622|+TP6)=0; wherein SGI612 is a displacement on the optical axis from a point on the object-side surface 162 of the sixth lens 160, through which the optical axis passes, to a point where the inflection point on the object-side surface 162, which is the second closest to the optical axis, projects on the optical axis, and SGI622 is a displacement on the optical axis from a point on the image-side surface 164 of the sixth lens 160, through which the optical axis passes, to a point where the inflection point on the image-side surface 164, which is the second closest to the optical axis, projects on the optical axis.

The sixth lens 160 satisfies: HIF611=2.24283 mm; HIF611/HOI=0.44857; HIF621=1.07376 mm; HIF621/HOI=0.21475; wherein HIF611 is a distance perpendicular to the optical axis between the optical axis and the inflection point on the object-side surface 162 of the sixth lens 160, which is the closest to the optical axis; HIF621 is a distance perpendicular to the optical axis between the optical axis and the inflection point on the image-side surface 164 of the sixth lens 160, which is the closest to the optical axis.

The sixth lens 160 satisfies: HIF612=2.48895 mm; HIF612/HOI=0.49779; wherein HIF612 is a distance perpendicular to the optical axis between the optical axis and the inflection point on the object-side surface 162 of the sixth lens 160, which is the second closest to the optical axis; HIF622 is a distance perpendicular to the optical axis between the optical axis and the inflection point on the image-side surface 164 of the sixth lens 160, which is the second closest to the optical axis.

The sixth lens 160 satisfies: HIF613=0 mm; HIF613/HOI=0; HIF623=0 mm; HIF623/HOI=0; wherein HIF613 is a distance perpendicular to the optical axis between the optical axis and the inflection point on the object-side surface 162 of the sixth lens 160, which is the third closest to the optical axis; HIF623 is a distance perpendicular to the optical axis between the optical axis and the inflection point on the image-side surface 164 of the sixth lens 160, which is the third closest to the optical axis.

The sixth lens 160 satisfies: HIF614=0 mm; HIF614/HOI=0; HIF624=0 mm; HIF624/HOI=0; wherein HIF614 is a distance perpendicular to the optical axis between the optical axis and the inflection point on the object-side surface 162 of the sixth lens 160, which is the fourth closest to the optical axis; HIF624 is a distance perpendicular to the optical axis between the optical axis and the inflection point on the image-side surface 164 of the sixth lens 160, which is the fourth closest to the optical axis.

The infrared rays filter 180 is made of glass and is disposed between the sixth lens 160 and the image plane 190. The infrared rays filter 180 gives no contribution to the focal length of the optical image capturing system 10.

The optical image capturing system 10 of the first optical embodiment has the following parameters, which are f=4.075 mm; f/HEP=1.4; HAF=50.001 deg; and tan(HAF)=1.1918, wherein f is a focal length of the optical image capturing system 10; HAF is a half of a maximum field angle; and HEP is an entrance pupil diameter.

The parameters of the lenses of the first optical embodiment are f1=−7.828 mm; |f/f1|=0.52060; f6=−4.886; and |f1>|f6|; wherein f1 is a focal length of the first lens 110; and f6 is a focal length of the sixth lens 160. 2

The first optical embodiment satisfies: |f2|+|f3|+1f4|+|f5|=95.50815 mm; |f1|+|f6|=12.71352 mm and |f2|+|f3|+|f4|+|f5|>|f1|+|f6|, wherein f2 is a focal length of the second lens 120, f3 is a focal length of the third lens 130, f4 is a focal length of the fourth lens 140, and f5 is a focal length of the fifth lens 150.

The optical image capturing system 10 of the first optical embodiment further satisfies: ΣPPR=f/f2+f/f4+f/f5=1.63290; ΣNPR=|f/f1|+f/f3|+|f/f6|=1.51305; ΣPPR/|ΣNPR|=1.07921; |f/f2|=0.69101; |f/f3|=0.15834; |f/f4|=0.06883; |f/f5|=0.87305; |f/f6|=0.83412; wherein PPR is a ratio of a focal length f of the optical image capturing system 10 to a focal length fp of each of the lenses with positive refractive power; and NPR is a ratio of a focal length f of the optical image capturing system 10 to a focal length fn of each of lenses with negative refractive power.

The optical image capturing system 10 of the first optical embodiment further satisfies: InTL+BFL=HOS; HOS=19.54120 mm; HOI=5.0 mm; HOS/HOI=3.90824; HOS/f=4.7952; InS=11.685 mm; and InS/HOS=0.59794; InTL/HOS=0.7936; wherein InTL is a distance between the object-side surface 112 of the first lens 110 and the image-side surface 164 of the sixth lens 160; HOS is a height of the optical image capturing system 10, i.e. a distance between the object-side surface 112 of the first lens 110 and the image plane 190; InS is a distance between the aperture 100 and the image plane 190; HOI is a half of a diagonal of an effective sensing area of the image sensor 192 (i.e., the maximum image height); and BFL is a distance between the image-side surface 164 of the sixth lens 160 and the image plane 190.

The optical image capturing system 10 of the first optical embodiment further satisfies: ΣTP=8.13899 mm; and ΣTP/InTL=0.52477, wherein ΣTP is a sum of the thicknesses of the lenses 110-160 with refractive power. It is helpful for the contrast of image and yield rate of manufacture and provides a suitable back focal length for installation of other elements.

The optical image capturing system 10 of the first optical embodiment further satisfies |R1/R2|=8.99987, wherein R1 is a radius of curvature of the object-side surface 112 of the first lens 110, and R2 is a radius of curvature of the image-side surface 114 of the first lens 110. It provides the first lens with a suitable positive refractive power to reduce the increase rate of the spherical aberration.

The optical image capturing system 10 of the first optical embodiment further satisfies (R11−R12)/(R11+R12)=1.27780, wherein R11 is a radius of curvature of the object-side surface 162 of the sixth lens 160, and R12 is a radius of curvature of the image-side surface 164 of the sixth lens 160. It may modify the astigmatic field curvature.

The optical image capturing system 10 of the first optical embodiment further satisfies: ΣPP=f2+f4+f5=69.770 mm; and f5/(f2+f4+f5)=0.067, wherein ΣPP is a sum of the focal lengths fp of each lens with positive refractive power. It is helpful to share the positive refractive power of a single lens to other positive lenses to avoid the significant aberration caused by the incident rays.

The optical image capturing system 10 of the first optical embodiment further satisfies: ΣNP=f1+f3+f6=−38.451 mm; and f6/(f1+f3+f6)=0.127, wherein μNP is a sum of the focal lengths fn of each lens with negative refractive power. It is helpful to share the negative refractive power of the sixth lens 160 to other negative lenses, which avoids the significant aberration caused by the incident rays.

The optical image capturing system 10 of the first optical embodiment further satisfies: IN12=6.418 mm; IN12/f=1.57491, wherein IN12 is a distance on the optical axis between the first lens 110 and the second lens 120. It may correct chromatic aberration and improve the performance.

The optical image capturing system 10 of the first optical embodiment further satisfies: IN56=0.025 mm; IN56/f=0.00613, wherein IN56 is a distance on the optical axis between the fifth lens 150 and the sixth lens 160. It may correct chromatic aberration and improve the performance.

The optical image capturing system 10 of the first optical embodiment further satisfies: TP1=1.934 mm; TP2=2.486 mm; and (TP1+IN12)/TP2=3.36005; wherein TP1 is a central thickness of the first lens 110 on the optical axis, and TP2 is a central thickness of the second lens 120 on the optical axis. It may control the sensitivity of manufacture of the optical image capturing system 10 and improve the performance.

The optical image capturing system 10 of the first optical embodiment further satisfies: TP5=1.072 mm; TP6=1.031 mm; and (TP6+IN56)/TP5=0.98555; wherein TP5 is a central thickness of the fifth lens 150 on the optical axis, TP6 is a central thickness of the sixth lens 160 on the optical axis, and IN56 is a distance on the optical axis between the fifth lens 150 and the sixth lens 160. It may control the sensitivity of manufacture of the system and lower the total height of the optical image capturing system 10.

The optical image capturing system 10 of the first optical embodiment further satisfies: IN34=0.401 mm; IN45=0.025 mm; and TP4/(IN34+TP4+IN45)=0.74376; wherein TP4 is a central thickness of the fourth lens 140 on the optical axis, IN34 is a distance on the optical axis between the third lens 130 and the fourth lens 140, and IN45 is a distance on the optical axis between the fourth lens 140 and the fifth lens 150. It may fine tune and correct the aberration of the incident rays layer by layer, and lower the total height of the optical image capturing system 10.

The optical image capturing system 10 of the first optical embodiment further satisfies: InRS51=−0.34789 mm; InRS52=−0.88185mm; |S51|/TP5=0.32458 and |InRS52/ TP5=0.82276; wherein InRS51 is a displacement from a point on the object-side surface 152 of the fifth lens 150 passed through by the optical axis to a point on the optical axis where a projection of the maximum effective semi diameter of the object-side surface 152 of the fifth lens 150 ends; InRS52 is a displacement from a point on the image-side surface 154 of the fifth lens 150 passed through by the optical axis to a point on the optical axis where a projection of the maximum effective semi diameter of the image-side surface 154 of the fifth lens 150 ends; and TP5 is a central thickness of the fifth lens 150 on the optical axis. It is helpful for manufacturing and shaping of the lenses and is helpful to reduce the size.

The optical image capturing system 10 of the first optical embodiment further satisfies: HVT51=0.515349 mm; HVT52=0 mm; wherein HVT51 a distance perpendicular to the optical axis between a critical point on the object-side surface 152 of the fifth lens 150 and the optical axis; and HVT52 a distance perpendicular to the optical axis between a critical point on the image-side surface 154 of the fifth lens 150 and the optical axis.

The optical image capturing system 10 of the first optical embodiment further satisfies: InRS61=−0.58390 mm; InRS62=0.41976 mm; |InRS61|/TP6=0.56616 and |InRS62|/TP6=0.40700; wherein InRS61 is a displacement from a point on the object-side surface 162 of the sixth lens 160 passed through by the optical axis to a point on the optical axis where a projection of the maximum effective semi diameter of the object-side surface 162 of the sixth lens 160 ends; InRS62 is a displacement from a point on the image-side surface 164 of the sixth lens 160 passed through by the optical axis to a point on the optical axis where a projection of the maximum effective semi diameter of the image-side surface 164 of the sixth lens 160 ends; and TP6 is a central thickness of the sixth lens 160 on the optical axis. It is helpful for manufacturing and shaping of the lenses and is helpful to reduce the size.

The optical image capturing system 10 of the first optical embodiment satisfies: HVT61=0 mm; HVT62=0 mm; wherein HVT61 is a distance perpendicular to the optical axis between a critical point on the object-side surface 162 of the sixth lens 160 and the optical axis; and HVT62 is a distance perpendicular to the optical axis between a critical point on the image-side surface 164 of the sixth lens 160 and the optical axis.

The optical image capturing system 10 of the first optical embodiment satisfies HVT51/HOI=0.1031. It is helpful for correction of the aberration of the peripheral view field of the optical image capturing system 10.

The optical image capturing system 10 of the first optical embodiment satisfies HVT51/ HOS=0.02634. It is helpful for correction of the aberration of the peripheral view field of the optical image capturing system 10.

In the current embodiment, the second lens 120, the third lens 130, and the sixth lens 160 have negative refractive power. The optical image capturing system 10 of the first optical embodiment further satisfies NA6/NA2<1, wherein NA2 is an Abbe number of the second lens 120; and NA6 is an Abbe number of the sixth lens 160. It may correct the aberration of the optical image capturing system 10.

The optical image capturing system 10 of the first optical embodiment further satisfies: TDT=2.124%; ODT=5.076%; wherein TDT is TV distortion; and ODT is optical distortion.

The parameters of the lenses of the first optical embodiment are listed in Table 1 and Table 2.

TABLE 1
f = 4.075 mm; f/HEP = 1.4; HAF = 50.000 deg

| | Radius of curvature | | Thickness | | Refractive | Abbe | Focal length |
|---|---|---|---|---|---|---|---|
| Surface | (mm) | | (mm) | Material | index | number | (mm) |
| 0 | Object | plane | plane | | | | |
| 1 | 1^{st} lens | −40.99625704 | 1.934 | plastic | 1.515 | 56.55 | −7.828 |
| 2 | | 4.555209289 | 5.923 | | | | |
| 3 | Aperture | plane | 0.495 | | | | |
| 4 | 2^{nd} lens | 5.333427366 | 2.486 | plastic | 1.544 | 55.96 | 5.897 |
| 5 | | −6.781659971 | 0.502 | | | | |
| 6 | 3^{rd} lens | −5.697794287 | 0.380 | plastic | 1.642 | 22.46 | −25.738 |
| 7 | | −8.883957518 | 0.401 | | | | |
| 8 | 4^{th} lens | 13.19225664 | 1.236 | plastic | 1.544 | 55.96 | 59.205 |
| 9 | | 21.55681832 | 0.025 | | | | |
| 10 | 5^{th} lens | 8.987806345 | 1.072 | plastic | 1.515 | 56.55 | 4.668 |
| 11 | | −3.158875374 | 0.025 | | | | |
| 12 | 6^{th} lens | −29.46491425 | 1.031 | plastic | 1.642 | 22.46 | −4.886 |
| 13 | | 3.593484273 | 2.412 | | | | |
| 14 | Infrared rays | plane | 0.200 | | 1.517 | 64.13 | |
| | filter | | | | | | |
| 15 | | plane | 1.420 | | | | |
| 16 | Image plane | plane | 0 | | | | |

Reference wavelength (d-line): 555 nm; the position of blocking light: the clear aperture of the first surface is 5.800 mm; the clear aperture of the third surface is 1.570 mm; the clear aperture of the fifth surface is 1.950.

TABLE 2
Coefficients of the aspheric surfaces

| Surface | 1 | 2 | 4 | 5 | 6 | 7 | 8 |
|---|---|---|---|---|---|---|---|
| k | 4.310876E+01 | −4.707622E+00 | 2.616025E+00 | 2.445397E+00 | 5.645686E+00 | −2.117147E+01 | −5.287220E+00 |
| A4 | 7.054243E−03 | 1.714312E−02 | −8.377541E−03 | −1.789549E−02 | −3.379055E−03 | −1.370959E−02 | −2.937377E−02 |
| A6 | −5.233264E−04 | −1.502232E−04 | −1.838068E−03 | −3.657520E−03 | −1.225453E−03 | 6.250200E−03 | 2.743532E−03 |
| A8 | 3.077890E−05 | −1.359611E−04 | 1.233332E−03 | −1.131622E−03 | −5.979572E−03 | −5.854426E−03 | −2.457574E−03 |
| A10 | −1.260650E−06 | 2.680747E−05 | −2.390895E−03 | 1.390351E−03 | 4.556449E−03 | 4.049451E−03 | 1.874319E−03 |
| A12 | 3.319093E−08 | −2.017491E−06 | 1.998555E−03 | −4.152857E−04 | −1.177175E−03 | −1.314592E−03 | −6.013661E−04 |
| A14 | −5.051600E−10 | 6.604615E−08 | −9.734019E−04 | 5.487286E−05 | 1.370522E−04 | 2.143097E−04 | 8.792480E−05 |
| A16 | 3.380000E−12 | −1.301630E−09 | 2.478373E−04 | −2.919339E−06 | −5.974015E−06 | −1.399894E−05 | −4.770527E−06 |

| Surface | 9 | 10 | 11 | 12 | 13 |
|---|---|---|---|---|---|
| k | 6.200000E+01 | −2.114008E+01 | −7.699904E+00 | −6.155476E+01 | −3.120467E−01 |
| A4 | −1.359965E−01 | −1.263831E−01 | −1.927804E−02 | −2.492467E−02 | −3.521844E−02 |
| A6 | 6.628518E−02 | 6.965399E−02 | 2.478376E−03 | −1.835360E−03 | 5.629654E−03 |
| A8 | −2.129167E−02 | −2.116027E−02 | 1.438785E−03 | 3.201343E−03 | −5.466925E−04 |
| A10 | 4.396344E−03 | 3.819371E−03 | −7.013749E−04 | −8.990757E−04 | 2.231154E−05 |
| A12 | −5.542899E−04 | −4.040283E−04 | 1.253214E−04 | 1.245343E−04 | 5.548990E−07 |
| A14 | 3.768879E−05 | 2.280473E−05 | −9.943196E−06 | −8.788363E−06 | −9.396920E−08 |
| A16 | −1.052467E−06 | −5.165452E−07 | 2.898397E−07 | 2.494302E−07 | 2.728360E−09 |

The figures related to the profile curve lengths obtained based on Table 1 and Table 2 are listed in the following table:

First optical embodiment (Reference wavelength: 555 nm)

| ARE | ½(HEP) | ARE value | ARE − ½(HEP) | 2(ARE/HEP) % | TP | ARE/TP (%) |
|---|---|---|---|---|---|---|
| 11 | 1.455 | 1.455 | −0.00033 | 99.98% | 1.934 | 75.23% |
| 12 | 1.455 | 1.495 | 0.03957 | 102.72% | 1.934 | 77.29% |
| 21 | 1.455 | 1.465 | 0.00940 | 100.65% | 2.486 | 58.93% |
| 22 | 1.455 | 1.495 | 0.03950 | 102.71% | 2.486 | 60.14% |
| 31 | 1.455 | 1.486 | 0.03045 | 102.09% | 0.380 | 391.02% |
| 32 | 1.455 | 1.464 | 0.00830 | 100.57% | 0.380 | 385.19% |
| 41 | 1.455 | 1.458 | 0.00237 | 100.16% | 1.236 | 117.95% |
| 42 | 1.455 | 1.484 | 0.02825 | 101.94% | 1.236 | 120.04% |
| 51 | 1.455 | 1.462 | 0.00672 | 100.46% | 1.072 | 136.42% |
| 52 | 1.455 | 1.499 | 0.04335 | 102.98% | 1.072 | 139.83% |
| 61 | 1.455 | 1.465 | 0.00964 | 100.66% | 1.031 | 142.06% |
| 62 | 1.455 | 1.469 | 0.01374 | 100.94% | 1.031 | 142.45% |
| ARS | EHD | ARS value | ARS − EHD | (ARS/EHD)% | TP | ARS/TP (%) |
| 11 | 5.800 | 6.141 | 0.341 | 105.88% | 1.934 | 317.51% |
| 12 | 3.299 | 4.423 | 1.125 | 134.10% | 1.934 | 228.70% |
| 21 | 1.664 | 1.674 | 0.010 | 100.61% | 2.486 | 67.35% |
| 22 | 1.950 | 2.119 | 0.169 | 108.65% | 2.486 | 85.23% |
| 31 | 1.980 | 2.048 | 0.069 | 103.47% | 0.380 | 539.05% |
| 32 | 2.084 | 2.101 | 0.017 | 100.83% | 0.380 | 552.87% |
| 41 | 2.247 | 2.287 | 0.040 | 101.80% | 1.236 | 185.05% |
| 42 | 2.530 | 2.813 | 0.284 | 111.22% | 1.236 | 227.63% |
| 51 | 2.655 | 2.690 | 0.035 | 101.32% | 1.072 | 250.99% |
| 52 | 2.764 | 2.930 | 0.166 | 106.00% | 1.072 | 273.40% |
| 61 | 2.816 | 2.905 | 0.089 | 103.16% | 1.031 | 281.64% |
| 62 | 3.363 | 3.391 | 0.029 | 100.86% | 1.031 | 328.83% |
| 72 | 5.800 | 6.141 | 0.341 | 105.88% | 1.934 | 317.51% |

The detail parameters of the first optical embodiment are listed in Table 1, in which the unit of the radius of curvature, thickness, and focal length are millimeter, and surface 0-16 indicates the surfaces of all elements in the optical image capturing system 10 in sequence from the object side to the image side. Table 2 is the list of coefficients of the aspheric surfaces, in which A1-A20 indicate the coefficients of aspheric surfaces from the first order to the twentieth order of each aspheric surface. The following embodiments have the similar diagrams and tables, which are the same as those of the first optical embodiment, so we do not describe it again.

### Second Optical Embodiment

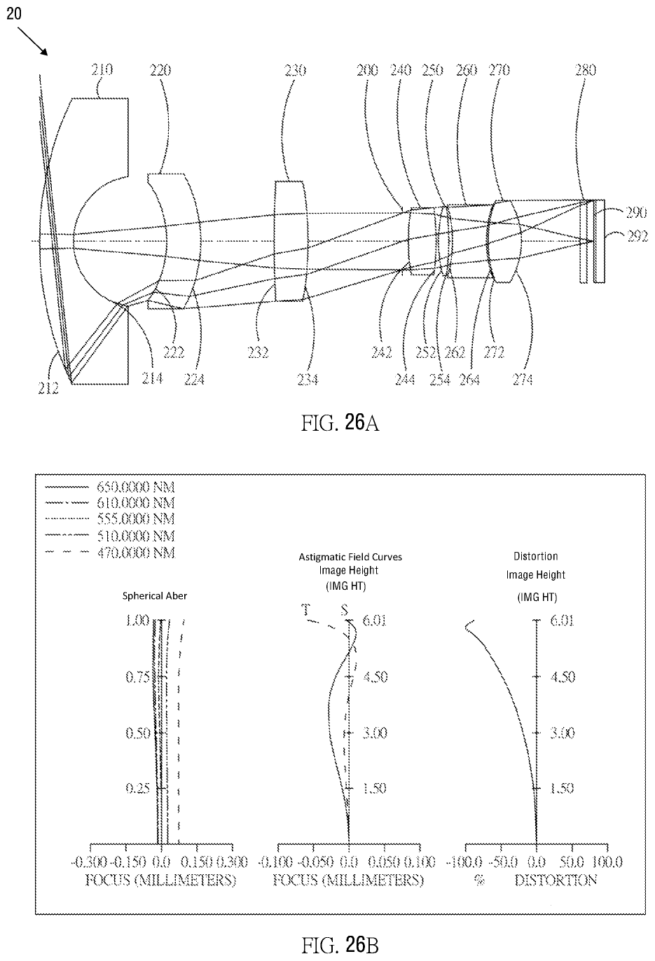

Referring to FIG. 26A, a schematic diagram of an optical image capturing system 20 according to a second optical embodiment of the present invention. Referring to FIG. 26B, curve diagrams of longitudinal spherical aberration, astigmatic field curves, and distortion in order from left to right according to the second optical embodiment of the present invention.

As shown in FIG. 26A, the optical image capturing system 20 of the second optical embodiment of the present invention includes, along an optical axis from an object side to an image side, a first lens 210, a second lens 220, a third lens 230, an aperture 200, a fourth lens 240, a fifth lens 250, a sixth lens 260, a seven lens 270, an infrared rays filter 280, an image plane 290, and an image sensor 292.

The first lens 210 has negative refractive power and is made of glass. An object-side surface 212 thereof, which faces the object side, is a convex spherical surface, and an image-side surface 214 thereof, which faces the image side, is a concave spherical surface.

The second lens 220 has negative refractive power and is made of glass. An object-side surface 222 thereof, which faces the object side, is a concave spherical surface, and an image-side surface 224 thereof, which faces the image side, is a convex spherical surface.

The third lens 230 has positive refractive power and is made of glass. An object-side surface 232, which faces the object side, is a convex spherical surface, and an image-side surface 234, which faces the image side, is a convex spherical surface.

The fourth lens 240 has positive refractive power and is made of glass. An object-side surface 242, which faces the object side, is a convex spherical surface, and an image-side surface 244, which faces the image side, is a convex spherical surface.

The fifth lens 250 has positive refractive power and is made of glass. An object-side surface 252, which faces the object side, is a convex spherical surface, and an image-side surface 254, which faces the image side, is a convex spherical surface.

The sixth lens 260 has negative refractive power and is made of glass. An object-side surface 262, which faces the object side, is a concave spherical surface, and an image-side surface 264, which faces the image side, is a concave spherical surface. Whereby, incident angle of each field of view for the sixth lens 260 could be effectively adjusted to improve aberration.

The seventh lens 270 has positive refractive power and is made of glass. An object-side surface 272, which faces the object side, is a convex spherical surface, and an image-side surface 274, which faces the image side, is a convex spherical surface. It may help to shorten the back focal length to keep small in size and reduce an incident angle of the light of an off-axis field of view and correct the aberration of the off-axis field of view.

The infrared rays filter 280 is made of glass and is disposed between the seventh lens 270 and the image plane 290. The infrared rays filter 280 gives no contribution to the focal length of the optical image capturing system 20.

The parameters of the lenses of the second optical embodiment are listed in Table 3 and Table 4.

TABLE 3
f = 4.7601 mm; f/HEP = 2.2; HAF = 95.98 deg

| | Radius of curvature | | Thickness | | Refractive | Abbe | Focal length |
|---|---|---|---|---|---|---|---|
| Surface | (mm) | | (mm) | Material | index | number | (mm) |
| 0 | Object | 1E+18 | 1E+18 | | | | |
| 1 | 1^{st} lens | 47.71478323 | 4.977 | glass | 2.001 | 29.13 | −12.647 |
| 2 | | 9.527614761 | 13.737 | | | | |
| 3 | 2^{nd} lens | −14.88061107 | 5.000 | glass | 2.001 | 29.13 | −99.541 |
| 4 | | −20.42046946 | 10.837 | | | | |
| 5 | 3^{rd} lens | 182.4762997 | 5.000 | glass | 1.847 | 23.78 | 44.046 |
| 6 | | −46.71963608 | 13.902 | | | | |
| 7 | Aperture | 1E+18 | 0.850 | | | | |
| 8 | 4^{th} lens | 28.60018103 | 4.095 | glass | 1.834 | 37.35 | 19.369 |
| 9 | | −35.08507586 | 0.323 | | | | |
| 10 | 5^{th} lens | 18.25991342 | 1.539 | glass | 1.609 | 46.44 | 20.223 |
| 11 | | −36.99028878 | 0.546 | | | | |
| 12 | 6^{th} lens | −18.24574524 | 5.000 | glass | 2.002 | 19.32 | −7.668 |
| 13 | | 15.33897192 | 0.215 | | | | |
| 14 | 7^{th} lens | 16.13218937 | 4.933 | glass | 1.517 | 64.20 | 13.620 |
| 15 | | −11.24007 | 8.664 | | | | |
| 16 | Infrared rays | 1E+18 | 1.000 | BK_7 | 1.517 | 64.2 | |
| | filter | | | | | | |
| 17 | | 1E+18 | 1.007 | | | | |
| 18 | Image plane | 1E+18 | −0.007 | | | | |

Reference wavelength (d-line): 555 nm.

TABLE 4
Coefficients of the aspheric surfaces

| Surface | 1 | 2 | 3 | 4 | 5 | 6 | 8 |
|---|---|---|---|---|---|---|---|
| k | 0.000000E+00 | 0.000000E+00 | 0.000000E+00 | 0.000000E+00 | 0.000000E+00 | 0.000000E+00 | 0.000000E+00 |
| A4 | 0.000000E+00 | 0.000000E+00 | 0.000000E+00 | 0.000000E+00 | 0.000000E+00 | 0.000000E+00 | 0.000000E+00 |
| A6 | 0.000000E+00 | 0.000000E+00 | 0.000000E+00 | 0.000000E+00 | 0.000000E+00 | 0.000000E+00 | 0.000000E+00 |
| A8 | 0.000000E+00 | 0.000000E+00 | 0.000000E+00 | 0.000000E+00 | 0.000000E+00 | 0.000000E+00 | 0.000000E+00 |
| A10 | 0.000000E+00 | 0.000000E+00 | 0.000000E+00 | 0.000000E+00 | 0.000000E+00 | 0.000000E+00 | 0.000000E+00 |
| A12 | 0.000000E+00 | 0.000000E+00 | 0.000000E+00 | 0.000000E+00 | 0.000000E+00 | 0.000000E+00 | 0.000000E+00 |
| Surface | 9 | 10 | 11 | 12 | 13 | 14 | 15 |
| k | 0.000000E+00 | 0.000000E+00 | 0.000000E+00 | 0.000000E+00 | 0.000000E+00 | 0.000000E+00 | 0.000000E+00 |
| A4 | 0.000000E+00 | 0.000000E+00 | 0.000000E+00 | 0.000000E+00 | 0.000000E+00 | 0.000000E+00 | 0.000000E+00 |
| A6 | 0.000000E+00 | 0.000000E+00 | 0.000000E+00 | 0.000000E+00 | 0.000000E+00 | 0.000000E+00 | 0.000000E+00 |
| A8 | 0.000000E+00 | 0.000000E+00 | 0.000000E+00 | 0.000000E+00 | 0.000000E+00 | 0.000000E+00 | 0.000000E+00 |
| A10 | 0.000000E+00 | 0.000000E+00 | 0.000000E+00 | 0.000000E+00 | 0.000000E+00 | 0.000000E+00 | 0.000000E+00 |
| A12 | 0.000000E+00 | 0.000000E+00 | 0.000000E+00 | 0.000000E+00 | 0.000000E+00 | 0.000000E+00 | 0.000000E+00 |

An equation of the aspheric surfaces of the second optical embodiment is the same as that of the first optical embodiment, and the definitions are the same as well.

The exact parameters of the second optical embodiment based on Table 3 and Table 4 are listed in the following table:

Second optical embodiment (Reference wavelength: 555 nm)

| \|f/f1\| | \|f/f2\| | \|f/f3\| | \|f/f4\| | \|f/f5\| | \|f/f6\| |
|---|---|---|---|---|---|
| 0.3764 | 0.0478 | 0.1081 | 0.2458 | 0.2354 | 0.6208 |
| \|f/f7\| | ΣPPR | ΣNPR | ΣPPR/\|ΣNPR\| | IN12/f | IN67/f |
| 0.3495 | 1.3510 | 0.6327 | 2.1352 | 2.8858 | 0.0451 |
| \|f1/f2\| | \|f2/f3\| | (TP1 + IN12)/TP2 | | (TP7 + IN67)/TP6 | |
| 0.1271 | 2.2599 | 3.7428 | | 1.0296 | |
| HOS | InTL | HOS/HOI | InS/HOS | ODT % | TDT % |
| 81.6178 | 70.9539 | 13.6030 | 0.3451 | −113.2790 | 84.4806 |
| HVT11 | HVT12 | HVT21 | HVT22 | HVT31 | HVT32 |
| 0.0000 | 0.0000 | 0.0000 | 0.0000 | 0.0000 | 0.0000 |
| HVT61 | HVT62 | HVT71 | HVT72 | HVT72/HOI | HVT72/HOS |
| 0.0000 | 0.0000 | 0.0000 | 0.0000 | 0.0000 | 0.0000 |
| PhiA | PhiC | PhiD | TH1 | TH2 | HOI |
| 11.962 mm | 12.362 mm | 12.862 mm | 0.25 mm | 0.2 mm | 6 mm |
| PhiA/PhiD | TH1 + TH2 | (TH1 + TH2)/ | (TH1 + TH2)/ | 2(TH1 + TH2)/ | InTL/HOS |
| | | HOI | HOS | PhiA | |
| 0.9676 | 0.45 mm | 0.075 | 0.0055 | 0.0752 | 0.86934 |

The figures related to the profile curve lengths obtained based on Table 3 and Table 4 are listed in the following table:

Second optical embodiment (Reference wavelength: 555 nm)

| ARE | ½(HEP) | ARE value | ARE − ½(HEP) | 2(ARE/HEP) % | TP | ARE/TP (%) |
|---|---|---|---|---|---|---|
| 11 | 1.082 | 1.081 | −0.00075 | 99.93% | 4.977 | 21.72% |
| 12 | 1.082 | 1.083 | 0.00149 | 100.14% | 4.977 | 21.77% |
| 21 | 1.082 | 1.082 | 0.00011 | 100.01% | 5.000 | 21.64% |
| 22 | 1.082 | 1.082 | −0.00034 | 99.97% | 5.000 | 21.63% |
| 31 | 1.082 | 1.081 | −0.00084 | 99.92% | 5.000 | 21.62% |
| 32 | 1.082 | 1.081 | −0.00075 | 99.93% | 5.000 | 21.62% |
| 41 | 1.082 | 1.081 | −0.00059 | 99.95% | 4.095 | 26.41% |
| 42 | 1.082 | 1.081 | −0.00067 | 99.94% | 4.095 | 26.40% |
| 51 | 1.082 | 1.082 | −0.00021 | 99.98% | 1.539 | 70.28% |
| 52 | 1.082 | 1.081 | −0.00069 | 99.94% | 1.539 | 70.25% |
| 61 | 1.082 | 1.082 | −0.00021 | 99.98% | 5.000 | 21.63% |
| 62 | 1.082 | 1.082 | 0.00005 | 100.00% | 5.000 | 21.64% |
| 71 | 1.082 | 1.082 | −0.00003 | 100.00% | 4.933 | 21.93% |
| 72 | 1.082 | 1.083 | 0.00083 | 100.08% | 4.933 | 21.95% |
| ARS | EHD | ARS value | ARS − EHD | (ARS/EHD)% | TP | ARS/TP (%) |
| 11 | 20.767 | 21.486 | 0.719 | 103.46% | 4.977 | 431.68% |
| 12 | 9.412 | 13.474 | 4.062 | 143.16% | 4.977 | 270.71% |
| 21 | 8.636 | 9.212 | 0.577 | 106.68% | 5.000 | 184.25% |
| 22 | 9.838 | 10.264 | 0.426 | 104.33% | 5.000 | 205.27% |
| 31 | 8.770 | 8.772 | 0.003 | 100.03% | 5.000 | 175.45% |
| 32 | 8.511 | 8.558 | 0.047 | 100.55% | 5.000 | 171.16% |
| 41 | 4.600 | 4.619 | 0.019 | 100.42% | 4.095 | 112.80% |
| 42 | 4.965 | 4.981 | 0.016 | 100.32% | 4.095 | 121.64% |
| 51 | 5.075 | 5.143 | 0.067 | 101.33% | 1.539 | 334.15% |
| 52 | 5.047 | 5.062 | 0.015 | 100.30% | 1.539 | 328.89% |
| 61 | 5.011 | 5.075 | 0.064 | 101.28% | 5.000 | 101.50% |
| 62 | 5.373 | 5.489 | 0.116 | 102.16% | 5.000 | 109.79% |
| 71 | 5.513 | 5.625 | 0.112 | 102.04% | 4.933 | 114.03% |
| 72 | 5.981 | 6.307 | 0.326 | 105.44% | 4.933 | 127.84% |

The results of the equations of the second optical embodiment based on

Table 3 and Table 4 are listed in the following table:

Values related to the inflection points of the second optical embodiment
(Reference wavelength: 555 nm)

| | | | | | | | |
|---|---|---|---|---|---|---|---|
| HIF111 | 0 | HIF111/HOI | 0 | SGI111 | 0 | \|SGI111\|/ | 0 |
| | | | | | | (\|SGI111\| + TP1) | |

### Third Optical Embodiment

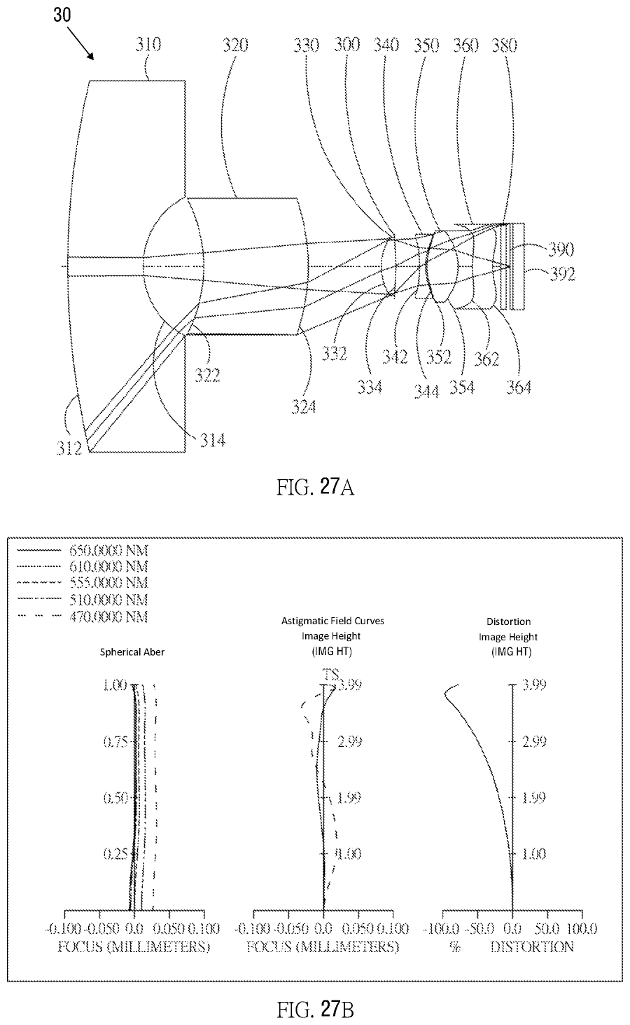

Referring to FIG. 27A, a schematic diagram of an optical image capturing system 30 according to a third optical embodiment of the present invention. Referring to FIG. 27B, curve diagrams of longitudinal spherical aberration, astigmatic field curves, and distortion in order from left to right according to the third optical embodiment of the present invention. As shown in FIG. 27A, the optical image capturing system 30 of the third optical embodiment of the present invention includes, along an optical axis from an object side to an image side, a first lens 310, a second lens 320, a third lens 330, an aperture 300, a fourth lens 340, a fifth lens 350, a sixth lens 360, an infrared rays filter 380, an image plane 390, and an image sensor 392.

The first lens 310 has negative refractive power and is made of glass. An object-side surface 312 thereof, which faces the object side, is a convex spherical surface, and an image-side surface 314 thereof, which faces the image side, is a concave spherical surface.

The second lens 320 has negative refractive power and is made of glass. An object-side surface 322 thereof, which faces the object side, is a concave spherical surface, and an image-side surface 324 thereof, which faces the image side, is a convex spherical surface.

The third lens 330 has positive refractive power and is made of plastic. An object-side surface 332 thereof, which faces the object side, is a convex aspheric surface, and an image-side surface 334 thereof, which faces the image side, is a convex aspheric surface. The image-side surface 334 has an inflection point.

The fourth lens 340 has negative refractive power and is made of plastic. An object-side surface 342, which faces the object side, is a concave aspheric surface, and an image-side surface 344, which faces the image side, is a concave aspheric surface. The image-side surface 344 has an inflection point.

The fifth lens 350 has positive refractive power and is made of plastic. An object-side surface 352, which faces the object side, is a convex aspheric surface, and an image-side surface 354, which faces the image side, is a convex aspheric surface.

The sixth lens 360 has positive refractive power and is made of plastic. An object-side surface 362, which faces the object side, is a convex aspheric surface, and an image-side surface 364, which faces the image side, is a concave aspheric surface.

The infrared rays filter 380 is made of glass and is disposed between the sixth lens 360 and the image plane 390. The infrared rays filter 380 gives no contribution to the focal length of the optical image capturing system 30.

The parameters of the lenses of the third optical embodiment are listed in Table 5 and Table 6.

TABLE 5
f = 2.808 mm; f/HEP = 1.6; HAF = 100 deg

| | Radius of curvature | | Thickness | | Refractive | Abbe | Focal length |
|---|---|---|---|---|---|---|---|
| Surface | (mm) | | (mm) | Material | index | number | (mm) |
| 0 | Object | 1E+18 | 1E+18 | | | | |
| 1 | 1^{st} lens | 71.398124 | 7.214 | Glass | 1.702 | 41.15 | −11.765 |
| 2 | | 7.117272355 | 5.788 | | | | |
| 3 | 2^{nd} lens | −13.29213699 | 10.000 | Glass | 2.003 | 19.32 | −4537.460 |
| 4 | | −18.37509887 | 7.005 | | | | |
| 5 | 3^{rd} lens | 5.039114804 | 1.398 | Plastic | 1.514 | 56.80 | 7.553 |
| 6 | | −15.53136631 | −0.140 | | | | |
| 7 | Aperture | 1E+18 | 2.378 | | | | |
| 8 | 4^{th} lens | −18.68613609 | 0.577 | Plastic | 1.661 | 20.40 | −4.978 |
| 9 | | 4.086545927 | 0.141 | | | | |
| 10 | 5^{th} lens | 4.927609282 | 2.974 | Plastic | 1.565 | 58.00 | 4.709 |
| 11 | | −4.551946605 | 1.389 | | | | |
| 12 | 6^{th} lens | 9.184876531 | 1.916 | Plastic | 1.514 | 56.80 | −23.405 |
| 13 | | 4.845500046 | 0.800 | | | | |
| 14 | Infrared rays | 1E+18 | 0.500 | BK_7 | 1.517 | 64.13 | |
| | filter | | | | | | |
| 15 | | 1E+18 | 0.371 | | | | |
| 16 | Image plane | 1E+18 | 0.005 | | | | |

Reference wavelength (d-line): 555 nm.

TABLE 6
Coefficients of the aspheric surfaces

| Surface | 1 | 2 | 3 | 4 | 5 | 6 | 8 |
|---|---|---|---|---|---|---|---|
| k | 0.000000E+00 | 0.000000E+00 | 0.000000E+00 | 0.000000E+00 | 1.318519E−01 | 3.120384E+00 | −1.494442E+01 |
| A4 | 0.000000E+00 | 0.000000E+00 | 0.000000E+00 | 0.000000E+00 | 6.405246E−05 | 2.103942E−03 | −1.598286E−03 |
| A6 | 0.000000E+00 | 0.000000E+00 | 0.000000E+00 | 0.000000E+00 | 2.278341E−05 | −1.050629E−04 | −9.177115E−04 |
| A8 | 0.000000E+00 | 0.000000E+00 | 0.000000E+00 | 0.000000E+00 | −3.672908E−06 | 6.168906E−06 | 1.011405E−04 |
| A10 | 0.000000E+00 | 0.000000E+00 | 0.000000E+00 | 0.000000E+00 | 3.748457E−07 | −1.224682E−07 | −4.919835E−06 |

| Surface | 9 | 10 | 11 | 12 | 13 |
|---|---|---|---|---|---|
| k | 2.744228E−02 | −7.864013E+00 | −2.263702E+00 | −4.206923E+01 | −7.030803E+00 |
| A4 | −7.291825E−03 | 1.405243E−04 | −3.919567E−03 | −1.679499E−03 | −2.640099E−03 |
| A6 | 9.730714E−05 | 1.837602E−04 | 2.683449E−04 | −3.518520E−04 | −4.507651E−05 |
| A8 | 1.101816E−06 | −2.173368E−05 | −1.229452E−05 | 5.047353E−05 | −2.600391E−05 |
| A10 | −6.849076E−07 | 7.328496E−07 | 4.222621E−07 | −3.851055E−06 | 1.161811E−06 |

An equation of the aspheric surfaces of the third optical embodiment is the same as that of the first optical embodiment, and the definitions are the same as well.

The exact parameters of the third optical embodiment based on Table 5 and Table 6 are listed in the following table:

Third optical embodiment (Reference wavelength: 555 nm)

| \|f/f1\| | \|f/f2\| | \|f/f3\| | \|f/f4\| | \|f/f5\| | \|f/f6\| |
|---|---|---|---|---|---|
| 0.23865 | 0.00062 | 0.37172 | 0.56396 | 0.59621 | 0.11996 |
| ΣPPR | ΣNPR | ΣPPR/\|ΣNPR\| | IN12/f | IN56/f | TP4/ |
| | | | | | (IN34 + TP4 + IN45) |
| 1.77054 | 0.12058 | 14.68400 | 2.06169 | 0.49464 | 0.19512 |
| \|f1/f2\| | \|f2/f3\| | (TP1 + IN12)/TP2 | | (TP6 + IN56)/TP5 | |
| 0.00259 | 600.74778 | 1.30023 | | 1.11131 | |
| HOS | InTL | HOS/HOI | InS/HOS | ODT % | TDT % |
| 42.31580 | 40.63970 | 10.57895 | 0.26115 | −122.32700 | 93.33510 |
| HVT51 | HVT52 | HVT61 | HVT62 | HVT62/HOI | HVT62/HOS |
| 0 | 0 | 2.22299 | 2.60561 | 0.65140 | 0.06158 |
| TP2/TP3 | TP3/TP4 | InRS61 | InRS62 | \|InRS61\|/TP6 | \|InRS62\|/TP6 |
| 7.15374 | 2.42321 | −0.20807 | −0.24978 | 0.10861 | 0.13038 |
| PhiA | PhiC | PhiD | TH1 | TH2 | HOI |
| 6.150 mm | 6.41 mm | 6.71 mm | 0.15 mm | 0.13 mm | 4 mm |
| PhiA/PhiD | TH1 + TH2 | (TH1 + TH2)/ | (TH1 + TH2)/ | 2(TH1 + TH2)/ | InTL/HOS |
| | | HOI | HOS | PhiA | |
| 0.9165 | 0.28 mm | 0.07 | 0.0066 | 0.0911 | 0.96039 |

The figures related to the profile curve lengths obtained based on Table 5 and Table 6 are listed in the following table:

Third optical embodiment (Reference wavelength: 555 nm)

| ARE | ½(HEP) | ARE value | ARE − ½(HEP) | 2(ARE/HEP) % | TP | ARE/TP (%) |
|---|---|---|---|---|---|---|
| 11 | 0.877 | 0.877 | −0.00036 | 99.96% | 7.214 | 12.16% |
| 12 | 0.877 | 0.879 | 0.00186 | 100.21% | 7.214 | 12.19% |
| 21 | 0.877 | 0.878 | 0.00026 | 100.03% | 10.000 | 8.78% |
| 22 | 0.877 | 0.877 | −0.00004 | 100.00% | 10.000 | 8.77% |
| 31 | 0.877 | 0.882 | 0.00413 | 100.47% | 1.398 | 63.06% |
| 32 | 0.877 | 0.877 | 0.00004 | 100.00% | 1.398 | 62.77% |
| 41 | 0.877 | 0.877 | −0.00001 | 100.00% | 0.577 | 152.09% |
| 42 | 0.877 | 0.883 | 0.00579 | 100.66% | 0.577 | 153.10% |
| 51 | 0.877 | 0.881 | 0.00373 | 100.43% | 2.974 | 29.63% |
| 52 | 0.877 | 0.883 | 0.00521 | 100.59% | 2.974 | 29.68% |
| 61 | 0.877 | 0.878 | 0.00064 | 100.07% | 1.916 | 45.83% |
| 62 | 0.877 | 0.881 | 0.00368 | 100.42% | 1.916 | 45.99% |
| ARS | EHD | ARS value | ARS − EHD | (ARS/EHD)% | TP | ARS/TP (%) |
| 11 | 17.443 | 17.620 | 0.178 | 101.02% | 7.214 | 244.25% |
| 12 | 6.428 | 8.019 | 1.592 | 124.76% | 7.214 | 111.16% |
| 21 | 6.318 | 6.584 | 0.266 | 104.20% | 10.000 | 65.84% |
| 22 | 6.340 | 6.472 | 0.132 | 102.08% | 10.000 | 64.72% |
| 31 | 2.699 | 2.857 | 0.158 | 105.84% | 1.398 | 204.38% |
| 32 | 2.476 | 2.481 | 0.005 | 100.18% | 1.398 | 177.46% |
| 41 | 2.601 | 2.652 | 0.051 | 101.96% | 0.577 | 459.78% |
| 42 | 3.006 | 3.119 | 0.113 | 103.75% | 0.577 | 540.61% |
| 51 | 3.075 | 3.171 | 0.096 | 103.13% | 2.974 | 106.65% |
| 52 | 3.317 | 3.624 | 0.307 | 109.24% | 2.974 | 121.88% |
| 61 | 3.331 | 3.427 | 0.095 | 102.86% | 1.916 | 178.88% |
| 62 | 3.944 | 4.160 | 0.215 | 105.46% | 1.916 | 217.14% |

The results of the equations of the third optical embodiment based on Table 5 and Table 6 are listed in the following table:

Values related to the inflection points of the third optical embodiment
(Reference wavelength: 555 nm)

| | | | | | | | |
|---|---|---|---|---|---|---|---|
| HIF321 | 2.0367 | HIF321/HOI | 0.5092 | SGI321 | −0.1056 | \|SGI321\|/(\|SGI321\| + TP3) | 0.0702 |
| HIF421 | 2.4635 | HIF421/HOI | 0.6159 | SGI421 | 0.5780 | \|SGI421\|/(\|SGI421\| + TP4) | 0.5005 |
| HIF611 | 1.2364 | HIF611/HOI | 0.3091 | SGI611 | 0.0668 | \|SGI611\|/(\|SGI611\| + TP6) | 0.0337 |
| HIF621 | 1.5488 | HIF621/HOI | 0.3872 | SGI621 | 0.2014 | \|SGI621\|/(\|SGI621\| + TP6) | 0.0951 |

### Fourth Optical Embodiment

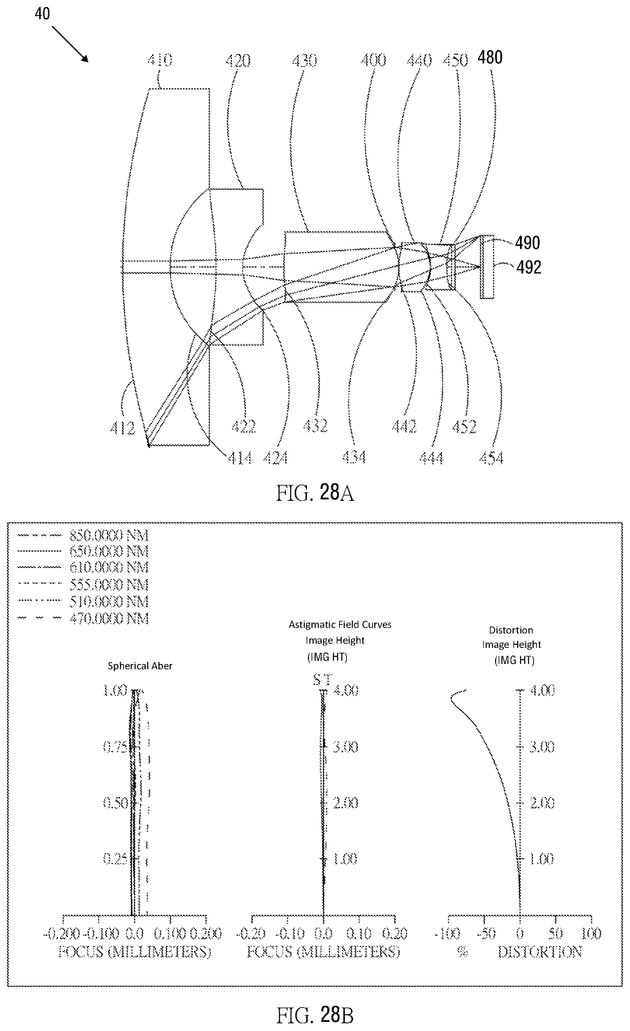

Referring to FIG. 28A, a schematic diagram of an optical image capturing system 40 according to a fourth optical embodiment of the present invention. Referring to FIG. 28B, curve diagrams of longitudinal spherical aberration, astigmatic field curves, and distortion in order from left to right according to the fourth optical embodiment of the present invention. As shown in FIG. 28A, the optical image capturing system 40 of the fourth optical embodiment of the present invention includes, along an optical axis from an object side to an image side, a first lens 410, a second lens 420, a third lens 430, an aperture 400, a fourth lens 440, a fifth lens 450, an infrared rays filter 480, an image plane 490, and an image sensor 492.

The first lens 410 has negative refractive power and is made of glass. An object-side surface 412 thereof, which faces the object side, is a convex spherical surface, and an image-side surface 414 thereof, which faces the image side, is a concave spherical surface.

The second lens 420 has negative refractive power and is made of plastic. An object-side surface 422 thereof, which faces the object side, is a concave aspheric surface, and an image-side surface 424 thereof, which faces the image side, is a concave aspheric surface. The object-side surface 422 has an inflection point.

The third lens 430 has positive refractive power and is made of plastic. An object-side surface 432 thereof, which faces the object side, is a convex aspheric surface, and an image-side surface 434 thereof, which faces the image side, is a convex aspheric surface. The object-side surface 432 has an inflection point.

The fourth lens 440 has positive refractive power and is made of plastic. An object-side surface 442, which faces the object side, is a convex aspheric surface, and an image-side surface 444, which faces the image side, is a convex aspheric surface. The object-side surface 442 has an inflection point.

The fifth lens 450 has negative refractive power and is made of plastic. An object-side surface 452, which faces the object side, is a concave aspheric surface, and an image-side surface 454, which faces the image side, is a concave aspheric surface. The object-side surface 452 has two inflection points. It may help to shorten the back focal length to keep small in size.

The infrared rays filter 480 is made of glass and is disposed between the fifth lens 450 and the image plane 490. The infrared rays filter 480 gives no contribution to the focal length of the optical image capturing system 40.

The parameters of the lenses of the fourth optical embodiment are listed in Table 7 and Table 8.

TABLE 7
f = 2.7883 mm; f/HEP = 1.8; HAF = 101 deg

| | Radius of curvature | | Thickness | | Refractive | Abbe | Focal length |
|---|---|---|---|---|---|---|---|
| Surface | (mm) | | (mm) | Material | index | number | (mm) |
| 0 | Object | 1E+18 | 1E+18 | | | | |
| 1 | 1^{st} lens | 76.84219 | 6.117399 | glass | 1.497 | 81.61 | −31.322 |
| 2 | | 12.62555 | 5.924382 | | | | |
| 3 | 2^{nd} lens | −37.0327 | 3.429817 | plastic | 1.565 | 54.5 | −8.70843 |
| 4 | | 5.88556 | 5.305191 | | | | |
| 5 | 3^{rd} lens | 17.99395 | 14.79391 | plastic | 1.565 | 58 | 9.94787 |
| 6 | | −5.76903 | −0.4855 | | | | |
| 7 | Aperture | 1E+18 | 0.535498 | | | | |
| 8 | 4^{th} lens | 8.19404 | 4.011739 | plastic | 1.565 | 58 | 5.24898 |
| 9 | | −3.84363 | 0.050366 | | | | |
| 10 | 5^{th} lens | −4.34991 | 2.088275 | plastic | 1.661 | 20.4 | −4.97515 |
| 11 | | 16.6609 | 0.6 | | | | |
| 12 | Infrared rays | 1E+18 | 0.5 | BK_7 | 1.517 | 64.13 | |
| | filter | | | | | | |
| 13 | | 1E+18 | 3.254927 | | | | |
| 14 | Image plane | 1E+18 | −0.00013 | | | | |

Reference wavelength (d-line): 555 nm.

TABLE 8
Coefficients of the aspheric surfaces

| Surface | 1 | 2 | 3 | 4 | 5 | 6 | 8 |
|---|---|---|---|---|---|---|---|
| k | 0.000000E+00 | 0.000000E+00 | 0.131249 | −0.069541 | −0.324555 | 0.009216 | −0.292346 |
| A4 | 0.000000E+00 | 0.000000E+00 | 3.99823E−05 | −8.55712E−04 | −9.07093E−04 | 8.80963E−04 | −1.02138E−03 |
| A6 | 0.000000E+00 | 0.000000E+00 | 9.03636E−08 | −1.96175E−06 | −1.02465E−05 | 3.14497E−05 | −1.18559E−04 |
| A8 | 0.000000E+00 | 0.000000E+00 | 1.91025E−09 | −1.39344E−08 | −8.18157E−08 | −3.15863E−06 | 1.34404E−05 |
| A10 | 0.000000E+00 | 0.000000E+00 | −1.18567E−11 | −4.17090E−09 | −2.42621E−09 | 1.44613E−07 | −2.80681E−06 |
| A12 | 0.000000E+00 | 0.000000E+00 | 0.000000E+00 | 0.000000E+00 | 0.000000E+00 | 0.000000E+00 | 0.000000E+00 |

| Surface | 9 | 10 | 11 |
|---|---|---|---|
| k | −0.18604 | −6.17195 | 27.541383 |
| A4 | 4.33629E−03 | 1.58379E−03 | 7.56932E−03 |
| A6 | −2.91588E−04 | −1.81549E−04 | −7.83858E−04 |
| A8 | 9.11419E−06 | −1.18213E−05 | 4.79120E−05 |
| A10 | 1.28365E−07 | 1.92716E−06 | −1.73591E−06 |
| A12 | 0.000000E+00 | 0.000000E+00 | 0.000000E+00 |

An equation of the aspheric surfaces of the fourth optical embodiment is the same as that of the first optical embodiment, and the definitions are the same as well.

The exact parameters of the fourth optical embodiment based on Table 7 and Table 8 are listed in the following table:

Fourth optical embodiment (Reference wavelength: 555 nm)

| \|f/f1\| | \|f/f2\| | \|f/f3\| | \|f/f4\| | \|f/f5\| | \|f1/f2\| |
|---|---|---|---|---|---|
| 0.08902 | 0.32019 | 0.28029 | 0.53121 | 0.56045 | 3.59674 |
| ΣPPR | ΣNPR | ΣPPR/\|ΣNPR\| | IN12/f | IN45/f | \|f2/f3\| |
| 1.4118 | 0.3693 | 3.8229 | 2.1247 | 0.0181 | 0.8754 |
| TP3/(IN23 + TP3 + IN34) | | (TP1 + IN12)/TP2 | | (TP5 + IN45)/TP4 | |
| 0.73422 | | 3.51091 | | 0.53309 | |
| HOS | InTL | HOS/HOI | InS/HOS | ODT % | TDT % |
| 46.12590 | 41.77110 | 11.53148 | 0.23936 | −125.266 | 99.1671 |
| HVT41 | HVT42 | HVT51 | HVT52 | HVT52/HOI | HVT52/HOS |
| 0.00000 | 0.00000 | 0.00000 | 0.00000 | 0.00000 | 0.00000 |
| TP2/TP3 | TP3/TP4 | InRS51 | InRS52 | \|InRS51\|/TP5 | \|InRS52\|/TP5 |
| 0.23184 | 3.68765 | −0.679265 | 0.5369 | 0.32528 | 0.25710 |
| PhiA | PhiC | PhiD | TH1 | TH2 | HOI |
| 5.598 mm | 5.858 mm | 6.118 mm | 0.13 mm | 0.13 mm | 4 mm |
| PhiA/PhiD | TH1 + TH2 | (TH1 + TH2)/ | (TH1 + TH2)/ | 2(TH1 + TH2)/ | InTL/HOS |
| | | HOI | HOS | PhiA | |
| 0.9150 | 0.26 mm | 0.065 | 0.0056 | 0.0929 | 0.90558 |

The figures related to the profile curve lengths obtained based on Table 7 and Table 8 are listed in the following table:

Fourth optical embodiment (Reference wavelength: 555 nm)

| ARE | ½(HEP) | ARE value | ARE − ½(HEP) | 2(ARE/HEP) % | TP | ARE/TP (%) |
|---|---|---|---|---|---|---|
| 11 | 0.775 | 0.774 | −0.00052 | 99.93% | 6.117 | 12.65% |
| 12 | 0.775 | 0.774 | −0.00005 | 99.99% | 6.117 | 12.66% |
| 21 | 0.775 | 0.774 | −0.00048 | 99.94% | 3.430 | 22.57% |
| 22 | 0.775 | 0.776 | 0.00168 | 100.22% | 3.430 | 22.63% |
| 31 | 0.775 | 0.774 | −0.00031 | 99.96% | 14.794 | 5.23% |
| 32 | 0.775 | 0.776 | 0.00177 | 100.23% | 14.794 | 5.25% |
| 41 | 0.775 | 0.775 | 0.00059 | 100.08% | 4.012 | 19.32% |
| 42 | 0.775 | 0.779 | 0.00453 | 100.59% | 4.012 | 19.42% |
| 51 | 0.775 | 0.778 | 0.00311 | 100.40% | 2.088 | 37.24% |
| 52 | 0.775 | 0.774 | −0.00014 | 99.98% | 2.088 | 37.08% |
| ARS | EHD | ARS value | ARS − EHD | (ARS/EHD)% | TP | ARS/TP (%) |
| 11 | 23.038 | 23.397 | 0.359 | 101.56% | 6.117 | 382.46% |
| 12 | 10.140 | 11.772 | 1.632 | 116.10% | 6.117 | 192.44% |
| 21 | 10.138 | 10.178 | 0.039 | 100.39% | 3.430 | 296.74% |
| 22 | 5.537 | 6.337 | 0.800 | 114.44% | 3.430 | 184.76% |
| 31 | 4.490 | 4.502 | 0.012 | 100.27% | 14.794 | 30.43% |
| 32 | 2.544 | 2.620 | 0.076 | 102.97% | 14.794 | 17.71% |
| 41 | 2.735 | 2.759 | 0.024 | 100.89% | 4.012 | 68.77% |
| 42 | 3.123 | 3.449 | 0.326 | 110.43% | 4.012 | 85.97% |
| 51 | 2.934 | 3.023 | 0.089 | 103.04% | 2.088 | 144.74% |
| 52 | 2.799 | 2.883 | 0.084 | 103.00% | 2.088 | 138.08% |

The results of the equations of the fourth optical embodiment based on

Table 7 and Table 8 are listed in the following table:

Values related to the inflection points of the fourth optical embodiment
(Reference wavelength: 555 nm)

| | | | | | | | |
|---|---|---|---|---|---|---|---|
| HIF211 | 6.3902 | HIF211/HOI | 1.5976 | SGI211 | −0.4793 | \|SGI211\|/(\|SGI211\| + TP2) | 0.1226 |
| HIF311 | 2.1324 | HIF311/HOI | 0.5331 | SGI311 | 0.1069 | \|SGI311\|/(\|SGI311\| + TP3) | 0.0072 |
| HIF411 | 2.0278 | HIF411/HOI | 0.5070 | SGI411 | 0.2287 | \|SGI411\|/(\|SGI411\| + TP4) | 0.0539 |
| HIF511 | 2.6253 | HIF511/HOI | 0.6563 | SGI511 | −0.5681 | \|SGI511\|/(\|SGI511\| + TP5) | 0.2139 |
| HIF512 | 2.1521 | HIF512/HOI | 0.5380 | SGI512 | −0.8314 | \|SGI512\|/(\|SGI512\| + TP5) | 0.2848 |

### Fifth Optical Embodiment

Referring to FIG. 29A, a schematic diagram of an optical image capturing system 50 according to a fifth optical embodiment of the present invention. Referring to FIG. 29B, curve diagrams of longitudinal spherical aberration, astigmatic field curves, and distortion in order from left to right according to the fifth optical embodiment of the present invention. As shown in FIG. 29A, an optical image capturing system 50 of the fifth embodiment of the present invention includes, along an optical axis from an object side to an image side, an aperture 500, a first lens 510, a second lens 520, a third lens 530, a fourth lens 540, an infrared rays filter 580, an image plane 590, and an image sensor 592.

The first lens 510 has positive refractive power and is made of plastic. An object-side surface 512, which faces the object side, is a convex aspheric surface, and an image-side surface 514, which faces the image side, is a convex aspheric surface. The object-side surface 512 has an inflection point.

The second lens 520 has negative refractive power and is made of plastic. An object-side surface 522 thereof, which faces the object side, is a convex aspheric surface, and an image-side surface 524 thereof, which faces the image side, is a concave aspheric surface. The object-side surface 522 has two inflection points, and the image-side surface 524 has an inflection point.

The third lens 530 has positive refractive power and is made of plastic. An object-side surface 532, which faces the object side, is a concave aspheric surface, and an image-side surface 534, which faces the image side, is a convex aspheric surface. The object-side surface 532 has three inflection points, and the image-side surface 534 has an inflection point.

The fourth lens 540 has negative refractive power and is made of plastic. An object-side surface 542, which faces the object side, is a concave aspheric surface, and an image-side surface 544, which faces the image side, is a concave aspheric surface. The object-side surface 542 has three inflection points, and the image-side surface 544 has an inflection point.

The infrared rays filter 580 is made of glass and is disposed between the fourth lens 540 and the image plane 590. The infrared rays filter 580 gives no contribution to the focal length of the optical image capturing system 50.

The parameters of the lenses of the fifth optical embodiment are listed in Table 9 and Table 10.

TABLE 9
f = 1.04102 mm; f/HEP = 1.4; HAF = 44.0346 deg

| | Radius of curvature | | Thickness | | Refractive | Abbe | Focal length |
|---|---|---|---|---|---|---|---|
| Surface | (mm) | | (mm) | Material | index | number | (mm) |
| 0 | Object | 1E+18 | 600 | | | | |
| 1 | Aperture | 1E+18 | −0.020 | | | | |
| 2 | 1^{st} lens | 0.890166851 | 0.210 | plastic | 1.545 | 55.96 | 1.587 |
| 3 | | −29.11040115 | −0.010 | | | | |
| 4 | 2^{nd} lens | 10.67765398 | 0.170 | plastic | 1.642 | 22.46 | −14.569 |
| 5 | | 4.977771922 | 0.049 | | | | |
| 6 | 3^{rd} lens | −1.191436932 | 0.349 | plastic | 1.545 | 55.96 | 0.510 |
| 7 | | −0.248990674 | 0.030 | | | | |
| 8 | 4^{th} lens | −38.08537212 | 0.176 | plastic | 1.642 | 22.46 | −0.569 |
| 9 | | 0.372574476 | 0.152 | | | | |
| 10 | Infrared rays | 1E+18 | 0.210 | BK_7 | 1.517 | 64.13 | |
| | filter | | | | | | |
| 11 | | 1E+18 | 0.185 | | | | |
| 12 | Image plane | 1E+18 | 0.005 | | | | |

Reference wavelength (d-line): 555 nm. The position of blocking light: the clear aperture of the fourth surface is 0.360 mm.

TABLE 10
Coefficients of the aspheric surfaces

| Surface | 2 | 3 | 4 | 5 | 6 | 7 |
|---|---|---|---|---|---|---|
| k | −1.106629E+00 | 2.994179E−07 | −7.788754E+01 | −3.440335E+01 | −8.522097E−01 | −4.735945E+00 |
| A4 | 8.291155E−01 | −6.401113E−01 | −4.958114E+00 | −1.875957E+00 | −4.878227E−01 | −2.490377E+00 |
| A6 | −2.398799E+01 | −1.265726E+01 | 1.299769E+02 | 8.568480E+01 | 1.291242E+02 | 1.524149E+02 |
| A8 | 1.825378E+02 | 8.457286E+01 | −2.736977E+03 | −1.279044E+03 | −1.979689E+03 | −4.841033E+03 |
| A10 | −6.211133E+02 | −2.157875E+02 | 2.908537E+04 | 8.661312E+03 | 1.456076E+04 | 8.053747E+04 |
| A12 | −4.719066E+02 | −6.203600E+02 | −1.499597E+05 | −2.875274E+04 | −5.975920E+04 | −7.936887E+05 |
| A14 | 0.000000E+00 | 0.000000E+00 | 2.992026E+05 | 3.764871E+04 | 1.351676E+05 | 4.811528E+06 |
| A16 | 0.000000E+00 | 0.000000E+00 | 0.000000E+00 | 0.000000E+00 | −1.329001E+05 | −1.762293E+07 |
| A18 | 0.000000E+00 | 0.000000E+00 | 0.000000E+00 | 0.000000E+00 | 0.000000E+00 | 3.579891E+07 |
| A20 | 0.000000E+00 | 0.000000E+00 | 0.000000E+00 | 0.000000E+00 | 0.000000E+00 | −3.094006E+07 |

| Surface | 8 | 9 |
|---|---|---|
| k | −2.277155E+01 | −8.039778E−01 |
| A4 | 1.672704E+01 | −7.613206E+00 |
| A6 | −3.260722E+02 | 3.374046E+01 |
| A8 | 3.373231E+03 | −1.368453E+02 |
| A10 | −2.177676E+04 | 4.049486E+02 |
| A12 | 8.951687E+04 | −9.711797E+02 |
| A14 | −2.363737E+05 | 1.942574E+03 |
| A16 | 3.983151E+05 | −2.876356E+03 |
| A18 | −4.090689E+05 | 2.562386E+03 |
| A20 | 2.056724E+05 | −9.943657E+02 |

An equation of the aspheric surfaces of the fifth optical embodiment is the same as that of the first optical embodiment, and the definitions are the same as well.

The exact parameters of the fifth optical embodiment based on Table 9 and

Table 10 are listed in the following table:

Fifth optical embodiment (Reference wavelength: 555 nm)

| InRS41 | InRS42 | HVT41 | HVT42 | ODT % | TDT % |
|---|---|---|---|---|---|
| −0.07431 | 0.00475 | 0.00000 | 0.53450 | 2.09403 | 0.84704 |
| \|f/f1\| | \|f/f2\| | \|f/f3\| | \|f/f4\| | \|f1/f2\| | \|f2/f3\| |
| 0.65616 | 0.07145 | 2.04129 | 1.83056 | 0.10890 | 28.56826 |
| ΣPPR | ΣNPR | ΣPPR/\|ΣNPR\| | ΣPP | ΣNP | f1/ΣPP |
| 2.11274 | 2.48672 | 0.84961 | −14.05932 | 1.01785 | 1.03627 |
| f4/ΣNP | IN12/f | IN23/f | IN34/f | TP3/f | TP4/f |
| 1.55872 | 0.10215 | 0.04697 | 0.02882 | 0.33567 | 0.16952 |
| InTL | HOS | HOS/HOI | InS/HOS | InTL/HOS | ΣTP/InTL |
| 1.09131 | 1.64329 | 1.59853 | 0.98783 | 0.66410 | 0.83025 |
| (TP1 + IN12)/ | (TP4 + IN34)/ | TP1/TP2 | TP3/TP4 | IN23/ | |
| TP2 | TP3 | | | (TP2 + IN23 + TP3) | |
| 1.86168 | 0.59088 | 1.23615 | 1.98009 | 0.08604 | |
| \|InRS41\|/TP4 | \|InRS42\|/TP4 | HVT42/HOI | HVT42/HOS | | |
| 0.4211 | 0.0269 | 0.5199 | 0.3253 | | |
| PhiA | PhiC | PhiD | TH1 | TH2 | HOI |
| 1.596 mm | 1.996 mm | 2.396 mm | 0.2 mm | 0.2 mm | 1.028 mm |
| PhiA/PhiD | TH1 + TH2 | (TH1 + TH2)/ | (TH1 + TH2)/ | 2(TH1 + TH2)/ | |
| | | HOI | HOS | PhiA | |
| 0.7996 | 0.4 mm | 0.3891 | 0.2434 | 0.5013 | |

The results of the equations of the fifth embodiment based on Table 9 and Table 10 are listed in the following table:

Values related to the inflection points of the fifth optical embodiment
(Reference wavelength: 555 nm)

| | | | | | | | |
|---|---|---|---|---|---|---|---|
| HIF111 | 0.28454 | HIF111/HOI | 0.27679 | SGI111 | 0.04361 | \|SGI111\|/(\|SGI111\| + TP1) | 0.17184 |
| HIF211 | 0.04198 | HIF211/HOI | 0.04083 | SGI211 | 0.00007 | \|SGI211\|/(\|SGI211\| + TP2) | 0.00040 |
| HIF212 | 0.37903 | HIF212/HOI | 0.36871 | SGI212 | −0.03682 | \|SGI212\|/(\|SGI212\| + TP2) | 0.17801 |
| HIF221 | 0.25058 | HIF221/HOI | 0.24376 | SGI221 | 0.00695 | \|SGI221\|/(\|SGI221\| + TP2) | 0.03927 |
| HIF311 | 0.14881 | HIF311/HOI | 0.14476 | SGI311 | −0.00854 | \|SGI311\|/(\|SGI311\| + TP3) | 0.02386 |
| HIF312 | 0.31992 | HIF312/HOI | 0.31120 | SGI312 | −0.01783 | \|SGI312\|/(\|SGI312\| + TP3) | 0.04855 |
| HIF313 | 0.32956 | HIF313/HOI | 0.32058 | SGI313 | −0.01801 | \|SGI313\|/(\|SGI313\| + TP3) | 0.04902 |
| HIF321 | 0.36943 | HIF321/HOI | 0.35937 | SGI321 | −0.14878 | \|SGI321\|/(\|SGI321\| + TP3) | 0.29862 |
| HIF411 | 0.01147 | HIF411/HOI | 0.01116 | SGI411 | −0.00000 | \|SGI411\|/(\|SGI411\| + TP4) | 0.00001 |
| HIF412 | 0.22405 | HIF412/HOI | 0.21795 | SGI412 | 0.01598 | \|SGI412\|/(\|SGI412\| + TP4) | 0.08304 |
| HIF421 | 0.24105 | HIF421/HOI | 0.23448 | SGI421 | 0.05924 | \|SGI421\|/(\|SGI421\| + TP4) | 0.25131 |

The figures related to the profile curve lengths obtained based on Table 9 and Table 10 are listed in the following table:

Fifth optical embodiment (Reference wavelength: 555 nm)

| ARE | ½(HEP) | ARE value | ARE − ½(HEP) | 2(ARE/HEP) % | TP | ARE/TP (%) |
|---|---|---|---|---|---|---|
| 11 | 0.368 | 0.374 | 0.00578 | 101.57% | 0.210 | 178.10% |
| 12 | 0.366 | 0.368 | 0.00240 | 100.66% | 0.210 | 175.11% |
| 21 | 0.372 | 0.375 | 0.00267 | 100.72% | 0.170 | 220.31% |
| 22 | 0.372 | 0.371 | −0.00060 | 99.84% | 0.170 | 218.39% |
| 31 | 0.372 | 0.372 | −0.00023 | 99.94% | 0.349 | 106.35% |
| 32 | 0.372 | 0.404 | 0.03219 | 108.66% | 0.349 | 115.63% |
| 41 | 0.372 | 0.373 | 0.00112 | 100.30% | 0.176 | 211.35% |
| 42 | 0.372 | 0.387 | 0.01533 | 104.12% | 0.176 | 219.40% |
| ARS | EHD | ARS value | ARS − EHD | (ARS/EHD)% | TP | ARS/TP (%) |
| 11 | 0.368 | 0.374 | 0.00578 | 101.57% | 0.210 | 178.10% |
| 12 | 0.366 | 0.368 | 0.00240 | 100.66% | 0.210 | 175.11% |
| 21 | 0.387 | 0.391 | 0.00383 | 100.99% | 0.170 | 229.73% |
| 22 | 0.458 | 0.460 | 0.00202 | 100.44% | 0.170 | 270.73% |
| 31 | 0.476 | 0.478 | 0.00161 | 100.34% | 0.349 | 136.76% |
| 32 | 0.494 | 0.538 | 0.04435 | 108.98% | 0.349 | 154.02% |
| 41 | 0.585 | 0.624 | 0.03890 | 106.65% | 0.176 | 353.34% |
| 42 | 0.798 | 0.866 | 0.06775 | 108.49% | 0.176 | 490.68% |

### Sixth Embodiment

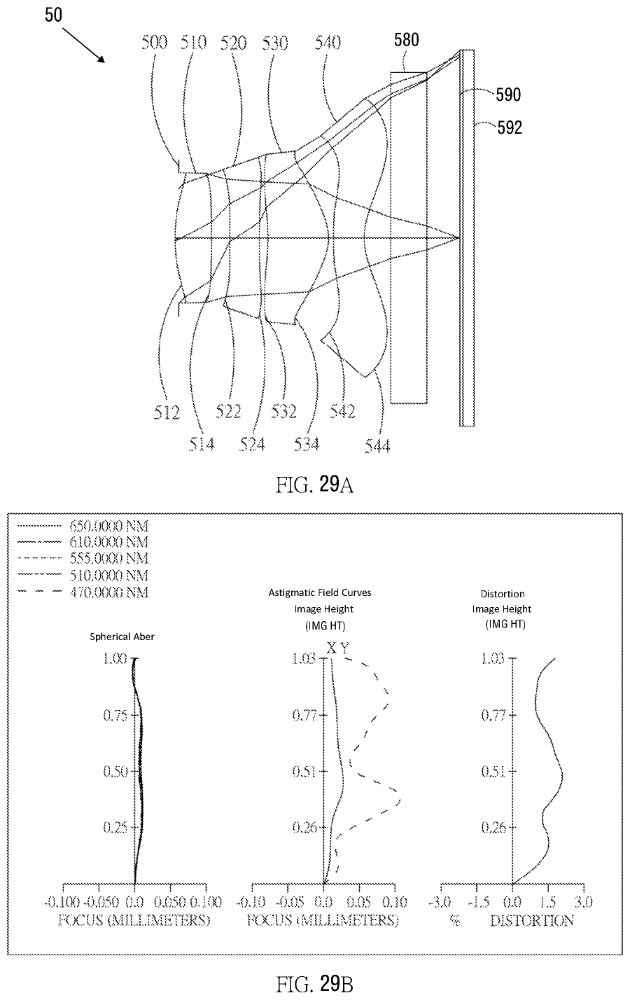

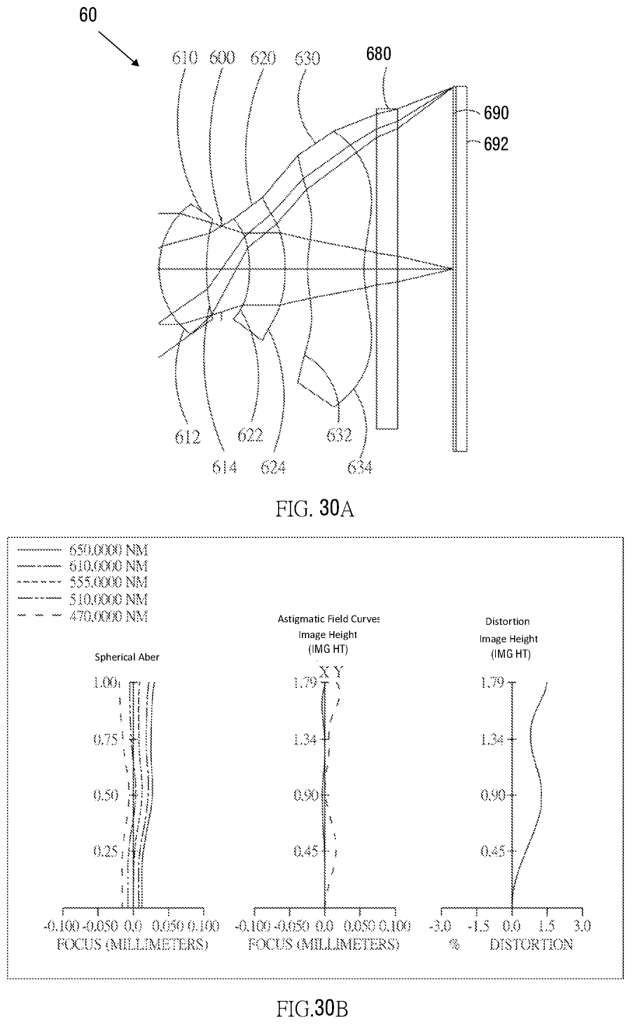

Referring to FIG. 30A, a schematic diagram of an optical image capturing system 60 according to a sixth optical embodiment of the present invention. Referring to FIG. 30B, curve diagrams of longitudinal spherical aberration, astigmatic field curves, and distortion in order from left to right according to the sixth optical embodiment of the present invention.

As shown in FIG. 30A, the optical image capturing system 60 of the sixth embodiment of the present invention includes, along an optical axis from an object side to an image side, a first lens 610, an aperture 600, a second lens 620, a third lens 630, an infrared rays filter 680, an image plane 690, and an image sensor 692.

The first lens 610 has positive refractive power and is made of plastic. An object-side surface 612, which faces the object side, is a convex aspheric surface, and an image-side surface 614, which faces the image side, is a concave aspheric surface.

The second lens 620 has negative refractive power and is made of plastic. An object-side surface 622 thereof, which faces the object side, is a concave aspheric surface, and an image-side surface 624 thereof, which faces the image side, is a convex aspheric surface. The image-side surface 624 has an inflection point.

The third lens 630 has positive refractive power and is made of plastic. An object-side surface 632, which faces the object side, is a convex aspheric surface, and an image-side surface 634, which faces the image side, is a concave aspheric surface. The object-side surface 632 has two inflection points, and the image-side surface 634 has an inflection point.

The infrared rays filter 680 is made of glass and is disposed between the third lens 630 and the image plane 690. The infrared rays filter 680 gives no contribution to the focal length of the optical image capturing system 60.

The parameters of the lenses of the sixth embodiment are listed in Table 11 and Table 12.

TABLE 11
f = 2.41135 mm; f/HEP = 2.22; HAF = 36 deg

| | Radius of curvature | | Thickness | | Refractive | Abbe | Focal length |
|---|---|---|---|---|---|---|---|
| Surface | (mm) | | (mm) | Material | index | number | (mm) |
| 0 | Object | 1E+18 | 600 | | | | |
| 1 | 1^{st} lens | 0.840352226 | 0.468 | plastic | 1.535 | 56.27 | 2.232 |
| 2 | | 2.271975602 | 0.148 | | | | |
| 3 | Aperture | 1E+18 | 0.277 | | | | |
| 4 | 2^{nd} lens | −1.157324239 | 0.349 | plastic | 1.642 | 22.46 | −5.221 |
| 5 | | −1.968404008 | 0.221 | | | | |
| 6 | 3^{rd} lens | 1.151874235 | 0.559 | plastic | 1.544 | 56.09 | 7.360 |
| 7 | | 1.338105159 | 0.123 | | | | |
| 8 | Infrared rays | 1E+18 | 0.210 | BK7 | 1.517 | 64.13 | |
| | filter | | | | | | |
| 9 | | 1E+18 | 0.547 | | | | |
| 10 | Image plane | 1E+18 | 0.000 | | | | |

Reference wavelength (d-line): 555 nm. The position of blocking light: the clear aperture of the first surface is 0.640 mm.

TABLE 12
Coefficients of the aspheric surfaces

| Surface | 1 | 2 | 4 | 5 | 6 | 7 |
|---|---|---|---|---|---|---|
| k | −2.019203E−01 | 1.528275E+01 | 3.743939E+00 | −1.207814E+01 | −1.276860E+01 | −3.034004E+00 |
| A4 | 3.944883E−02 | −1.670490E−01 | −4.266331E−01 | −1.696843E+00 | −7.396546E−01 | −5.308488E−01 |
| A6 | 4.774062E−01 | 3.857435E+00 | −1.423859E+00 | 5.164775E+00 | 4.449101E−01 | 4.374142E−01 |
| A8 | −1.528780E+00 | −7.091408E+01 | 4.119587E+01 | −1.445541E+01 | 2.622372E−01 | −3.111192E−01 |
| A10 | 5.133947E+00 | 6.365801E+02 | −3.456462E+02 | 2.876958E+01 | −2.510946E−01 | 1.354257E−01 |
| A12 | −6.250496E+00 | −3.141002E+03 | 1.495452E+03 | −2.662400E+01 | −1.048030E−01 | −2.652902E−02 |
| A14 | 1.068803E+00 | 7.962834E+03 | −2.747802E+03 | 1.661634E+01 | 1.462137E−01 | −1.203306E−03 |
| A16 | 7.995491E+00 | −8.268637E+03 | 1.443133E+03 | −1.327827E+01 | −3.676651E−02 | 7.805611E−04 |

An equation of the aspheric surfaces of the sixth optical embodiment is the same as that of the first optical embodiment, and the definitions are the same as well.

The exact parameters of the sixth optical embodiment based on Table 11 and Table 12 are listed in the following table:

Sixth optical embodiment (Reference wavelength: 555 nm)

| \|f/f1\| | \|f/f2\| | \|f/f3\| | \|f1/f2\| | \|f2/f3\| | TP1/TP2 |
|---|---|---|---|---|---|
| 1.08042 | 0.46186 | 0.32763 | 2.33928 | 1.40968 | 1.33921 |
| ΣPPR | ΣNPR | ΣPPR/\|ΣNPR\| | IN12/f | IN23/f | TP2/TP3 |
| 1.40805 | 0.46186 | 3.04866 | 0.17636 | 0.09155 | 0.62498 |
| TP2/ | | (TP1 + IN12)/TP2 | | (TP3 + IN23)/TP2 | |
| (IN12 + TP2 + IN23) | | | | | |
| 0.35102 | | 2.23183 | | 2.23183 | |
| HOS | InTL | HOS/HOI | InS/HOS | \|ODT\| % | \|TDT\| % |
| 2.90175 | 2.02243 | 1.61928 | 0.78770 | 1.50000 | 0.71008 |
| HVT21 | HVT22 | HVT31 | HVT32 | HVT32/HOI | HVT32/ |
| | | | | | HOS |
| 0.00000 | 0.00000 | 0.46887 | 0.67544 | 0.37692 | 0.23277 |
| PhiA | PhiC | PhiD | TH1 | TH2 | HOI |
| 2.716 mm | 3.116 mm | 3.616 mm | 0.25 mm | 0.2 mm | 1.792 mm |
| PhiA/ | TH1 + TH2 | (TH1 + TH2)/ | (TH1 + TH2)/ | 2(TH1 + TH2)/ | InTL/HOS |
| PhiD | | HOI | HOS | PhiA | |
| 0.7511 | 0.45 mm | 0.2511 | 0.1551 | 0.3314 | 0.69696 |

The results of the equations of the sixth optical embodiment based on Table 11 and Table 12 are listed in the following table:

Values related to the inflection points of the sixth optical embodiment
(Reference wavelength: 555 nm)

| | | | | | | | |
|---|---|---|---|---|---|---|---|
| HIF221 | 0.5599 | HIF221/HOI | 0.3125 | SGI221 | −0.1487 | \|SGI221\|/(\|SGI221\| + TP2) | 0.2412 |
| HIF311 | 0.2405 | HIF311/HOI | 0.1342 | SGI311 | 0.0201 | \|SGI311\|/(\|SGI311\| + TP3) | 0.0413 |
| HIF312 | 0.8255 | HIF312/HOI | 0.4607 | SGI312 | −0.0234 | \|SGI312\|/(\|SGI312\| + TP3) | 0.0476 |
| HIF321 | 0.3505 | HIF321/HOI | 0.1956 | SGI321 | 0.0371 | \|SGI321\|/(\|SGI321\| + TP3) | 0.0735 |

The figures related to the profile curve lengths obtained based on Table 11 and Table 12 are listed in the following table:

Sixth optical embodiment (Reference wavelength: 555 nm)

| ARE | ½(HEP) | ARE value | ARE − ½(HEP) | 2(ARE/HEP) % | TP | ARE/TP (%) |
|---|---|---|---|---|---|---|
| 11 | 0.546 | 0.598 | 0.052 | 109.49% | 0.468 | 127.80% |
| 12 | 0.500 | 0.506 | 0.005 | 101.06% | 0.468 | 108.03% |
| 21 | 0.492 | 0.528 | 0.036 | 107.37% | 0.349 | 151.10% |
| 22 | 0.546 | 0.572 | 0.026 | 104.78% | 0.349 | 163.78% |
| 31 | 0.546 | 0.548 | 0.002 | 100.36% | 0.559 | 98.04% |
| 32 | 0.546 | 0.550 | 0.004 | 100.80% | 0.559 | 98.47% |
| ARS | EHD | ARS value | ARS − EHD | (ARS/EHD)% | TP | ARS/TP (%) |
| 11 | 0.640 | 0.739 | 0.099 | 115.54% | 0.468 | 158.03% |
| 12 | 0.500 | 0.506 | 0.005 | 101.06% | 0.468 | 108.03% |
| 21 | 0.492 | 0.528 | 0.036 | 107.37% | 0.349 | 151.10% |
| 22 | 0.706 | 0.750 | 0.044 | 106.28% | 0.349 | 214.72% |
| 31 | 1.118 | 1.135 | 0.017 | 101.49% | 0.559 | 203.04% |
| 32 | 1.358 | 1.489 | 0.131 | 109.69% | 0.559 | 266.34% |

The optical image capturing system could be one of groups formed by electronic portable devices, electronic wearable devices, electronic monitoring devices, electronic information devices, electronic communication devices, machine vision devices, and automotive electronic devices, and could reduce a required mechanical space and increase a viewing area of the screen by using different lens assemblies with different numbers of lens to meet various requirements.

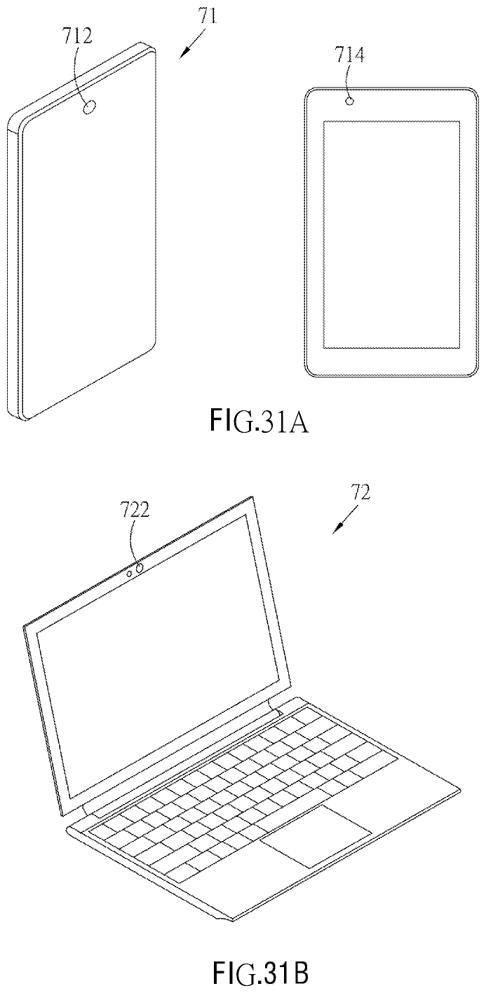

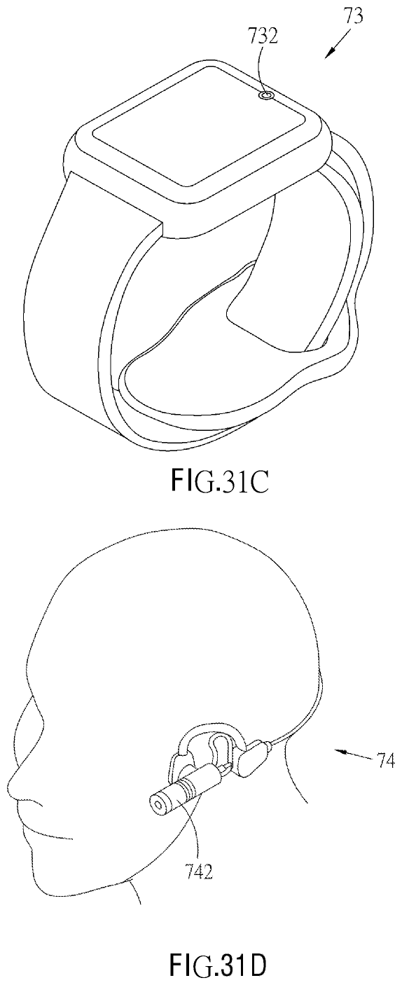

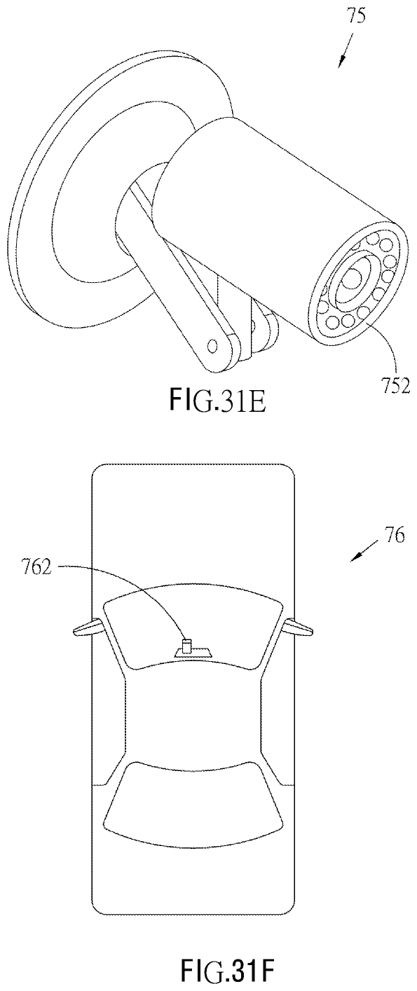

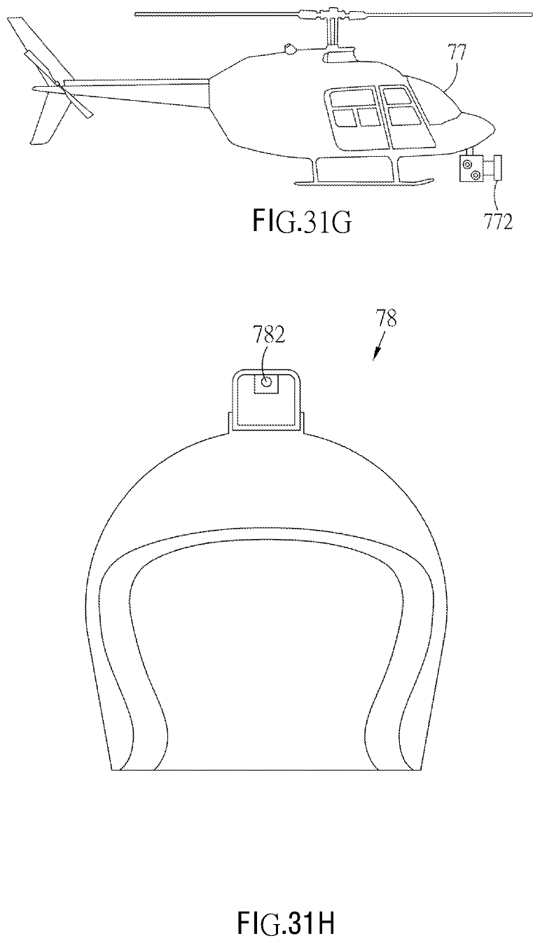

Referring to FIG. 31A, an adjustable shading module 712 and an adjustable shading module 714 (e.g. a front camera) of the present invention could be applied to a mobile communication device 71 (e.g. a smart phone). Referring to FIG. 31B, an adjustable shading module 722 of the present invention could be applied to a mobile information device 72 (e.g. a notebook). Referring to FIG. 31C, an adjustable shading module 732 of the present invention could be applied to a smart watch 73 Referring to FIG. 31D, an adjustable shading module 742 of the present invention could be applied to a smart headset 74. Referring to FIG. 31E, an adjustable shading module 752 of the present invention could be applied to a security monitoring device 75 (IP Cam). Referring to 31F, an adjustable shading module 762 of the present invention could be applied to a vehicle video device 76. Referring to FIG. 31G, an adjustable shading module 772 of the present invention could be applied to a drone 77. Referring to FIG. 31H, an adjustable shading module 782 of the present invention could be applied to an extreme sports video device 78.

It must be pointed out that the embodiments described above are only some embodiments of the present invention. All equivalent structures which employ the concepts disclosed in this specification and the appended claims should fall within the scope of the present invention.

What is claimed is:

1. An adjustable shading module, comprising:
a base having an optical mounting portion and a cover mounting portion that are integrally formed as a monolithic unit, wherein the optical mounting portion has a chamber and a through-hole communicating with the chamber, and the cover mounting portion is located on a side of the optical mounting portion;
an optical image capturing system having an optical lens assembly, wherein the optical lens assembly has an optical axis and at least two lenses arranged in order along the optical axis from an object side to an image side; the optical lens assembly is disposed in the chamber, and an object side of the optical lens assembly faces towards the through-hole, and the optical axis passes through the through-hole;
at least one shading cover disposed on the cover mounting portion, wherein the at least one shading cover is movable on a moving path to close or open the through-hole;
the moving path is not parallel to the optical axis;
wherein the optical lens assembly satisfies:
1.0≤f/HEP≤10.0;
0 deg<HAF≤150 deg;
wherein f is a focal length of the optical lens assembly; HEP is an entrance pupil diameter of the optical lens assembly; HAF is a half of a maximum field angle of the optical lens assembly.

2. The adjustable shading module as claimed in claim 1, wherein the cover mounting portion has a guiding groove accompany with the moving path; the at least one shading cover is disposed in the guiding groove; a side of the at least one shading cover opposite to the through-hole has a forced portion that is adapted to be pushed to move on the moving path.

3. The adjustable shading module as claimed in claim 2, wherein the forced portion is a recess or a projection.

4. The adjustable shading module as claimed in claim 1, further comprising at least one at least one driving device for driving the at least one shading cover to move on the moving path relative to the optical lens assembly, wherein the base has a driver mounting portion that is integrally formed with the optical mounting portion and the cover mounting portion; the driver mounting portion has at least one receiving space; the at least one driving device is disposed in the at least one receiving space.

5. The adjustable shading module as claimed in claim 4, wherein the at least one driving device comprises an electromagnet; the at least one shading cover comprises a magnetic member; the electromagnet generates a magnetic field based on a received current to repel or attract the magnetic member, thereby driving the at least one shading cover to displace.

6. The adjustable shading module as claimed in claim 4, wherein the at least one driving device comprises a motor connected to the at least one shading cover to drive the at least one shading cover to move on the moving path relative to the optical lens assembly.

7. The adjustable shading module as claimed in claim 4, wherein the at least one receiving space and the chamber are adjacent and are arranged along a reference axis that is not parallel to the optical axis.

8. The adjustable shading module as claimed in claim 7, wherein the reference axis is perpendicular to the optical axis.

9. The adjustable shading module as claimed in claim 4, wherein the at least one driving device comprises a first driving unit and a second driving unit; the at least one shading cover comprises a first shading cover and a second shading cover; the first shading cover is driven by the first driving unit to move on a first moving path to close or open the through-hole; the second shading cover is driven by the second driving unit to move on a second moving path to close or open the through-hole.

10. The adjustable shading module as claimed in claim 9, wherein the first shading cover has a first light-transmitting hole; the second shading cover has a second light-transmitting hole; the first shading cover and the second shading cover are respectively driven by the first driving unit and the second driving unit to move to a closed position, a partial-open position, and an open position; the first light-transmitting hole and the second light-transmitting hole respectively have a first projection surface and a second projection surface on a reference surface perpendicular to the optical axis;
the first projection surface and the second projection surface not overlap when the first shading cover and the second shading cover are located at the closed position; the first projection surface and the second projection surface partially overlap when the first shading cover and the second shading cover are located at the partial-open position; the first projection surface and the second projection surface completely overlap when the first shading cover and the second shading cover are located at the open position.

11. The adjustable shading module as claimed in claim 9, wherein the at least one receiving space comprises a first receiving space and a second receiving space; the chamber is located between the first receiving space and the second receiving space; the first driving unit is received in the first receiving space, and the second driving unit is received in the second receiving space.

12. The adjustable shading module as claimed in claim 7, wherein the at least one driving device comprises a plurality of electromagnets arranged along the reference axis; the at least one shading cover comprises a magnetic member; the electromagnets generate a magnetic field based on a received current to repel or attract the magnetic member, thereby driving the at least one shading cover to displace.

13. The adjustable shading module as claimed in claim 1, wherein the at least one shading cover has at least one light-transmitting hole; the at least one shading cover is movable along the moving path to a position that the at least one light-transmitting hole communicates with the through-hole to open the through-hole or to a position that the at least one light-transmitting hole does not communicate with the through-hole to close the through-hole.

14. The adjustable shading module as claimed in claim 13, wherein the at least one shading cover has a plurality of light-transmitting holes; the light-transmitting holes respectively have different diameters and are disposed on the at least one shading cover along the moving path.

15. The adjustable shading module as claimed in claim 1, wherein the moving path is perpendicular to the optical axis.

16. The adjustable shading module as claimed in claim 1, wherein the moving path is a straight line or a curve.

17. The adjustable shading module as claimed in claim 1, wherein the optical lens assembly comprises three to eight lenses with refractive power and satisfies:
0.1≤InTL/HOS≤0.95;
wherein HOS is a distance on the optical axis between an image plane of the optical lens assembly and an object-side surface of one of the lenses that is the closest to the object side; InTL is a distance from the object-side surface of one of the lenses that is the closest to the object side to an image-side surface of one of the lenses that is the closest to the image side.

18. The adjustable shading module as claimed in claim 1, wherein the optical lens assembly further comprises an aperture and satisfies:
0.2≤InS/HOS≤1.1;
wherein InS is a distance between the aperture and an image plane of the optical lens assembly on the optical axis; HOS is a distance on the optical axis between the image plane and an object-side surface of one of the at least two lenses that is the closest to the object side.

19. An adjustable shading module, comprising:
a base having an optical mounting portion and a cover mounting portion that are integrally formed as a monolithic unit, wherein the optical mounting portion has a chamber and a through-hole communicating with the chamber, and the cover mounting portion is located on a side of the optical mounting portion;
an optical image capturing system having an optical lens assembly and an image sensor, wherein the optical lens assembly has an optical axis and at least two lenses arranged in order along the optical axis from an object side to an image side; the optical lens assembly is disposed in the chamber, and the object side of the optical lens assembly faces towards the through-hole, and the optical axis passes through the through-hole; the image sensor is disposed in the chamber and is located at an image plane of the optical lens assembly;
at least one shading cover disposed on the cover mounting portion, wherein the at least one shading cover is movable on a moving path to close or open the through-hole, and the moving path is not parallel to the optical axis;
wherein the optical lens assembly satisfies:
0.5≤HOS/f≤150; and
1.0≤f/HEP≤10.0;
wherein f is a focal length of the optical lens assembly; HEP is an entrance pupil diameter of the optical lens assembly; HOS is a distance on the optical axis between the image plane and an object-side surface of one of the at least two lenses that is the closest to the object side.

20. The adjustable shading module as claimed in claim 19, wherein the cover mounting portion has a guiding groove accompany with the moving path; the at least one shading cover is disposed in the guiding groove; a side of the at least one shading cover opposite to the through-hole has a forced portion that is adapted to be pushed to move on the moving path.

21. The adjustable shading module as claimed in claim 20, wherein the forced portion is a recess or a projection.

22. The adjustable shading module as claimed in claim 19, further comprising at least one driving device for driving the at least one shading cover to move on the moving path relative to the optical lens assembly, wherein the base has a driver mounting portion that is integrally formed with the optical mounting portion and the cover mounting portion; the driver mounting portion has at least one receiving space; the at least one driving device is disposed in the at least one receiving space.

23. The adjustable shading module as claimed in claim 22, wherein the at least one driving device comprises an electromagnet; the at least one shading cover comprises a magnetic member; the electromagnet generates a magnetic field based on a received current to repel or attract the magnetic member, thereby driving the at least one shading cover to displace.

24. The adjustable shading module as claimed in claim 22, wherein the at least one driving device comprises a motor connected to the at least one shading cover to drive the at least one shading cover to move on the moving path relative to the optical lens assembly.

25. The adjustable shading module as claimed in claim 22, wherein the at least one receiving space and the chamber are adjacent and are arranged along a reference axis that is not parallel to the optical axis.

26. The adjustable shading module as claimed in claim 25, wherein the reference axis is perpendicular to the optical axis.

27. The adjustable shading module as claimed in claim 22, wherein the at least one driving device comprises a first driving unit and a second driving unit; the at least one shading cover comprises a first shading cover and a second shading cover; the first shading cover is driven by the first driving unit to move on a first moving path to close or open the through-hole; the second shading cover is driven by the second driving unit to move on a second moving path to close or open the through-hole.

28. The adjustable shading module as claimed in claim 27, wherein the first shading cover has a first light-transmitting hole; the second shading cover has a second light-transmitting hole; the first shading cover and the second shading cover are respectively driven by the first driving unit and the second driving unit to move to a closed position, a partial-open position, and an open position; the first light-transmitting hole and the second light-transmitting hole respectively have a first projection surface and a second projection surface on a reference surface perpendicular to the optical axis;
the first projection surface and the second projection surface not overlap when the first shading cover and the second shading cover are located at the closed position; the first projection surface and the second projection surface partially overlap when the first shading cover and the second shading cover are located at the partial-open position; the first projection surface and the second projection surface completely overlap when the first shading cover and the second shading cover are located at the open position.

29. The adjustable shading module as claimed in claim 27, wherein the at least one receiving space comprises a first receiving space and a second receiving space; the chamber is located between the first receiving space and the second receiving space; the first driving unit is received in the first receiving space, and the second driving unit is received in the second receiving space.

30. The adjustable shading module as claimed in claim 25, wherein the at least one driving device comprises a plurality of electromagnets arranged along the reference axis; the at least one shading cover comprises a magnetic member; the electromagnets generate a magnetic field based on a received current to repel or attract the magnetic member, thereby driving the at least one shading cover to displace.

31. The adjustable shading module as claimed in claim 19, wherein the at least one shading cover has at least one light-transmitting hole; the at least one shading cover is movable along the moving path to a position that the at least one light-transmitting hole communicates with the through-hole to open the through-hole or to a position that the at least one light-transmitting hole does not communicate with the through-hole to close the through-hole.

32. The adjustable shading module as claimed in claim 31, wherein the at least one shading cover has a plurality of light-transmitting holes; the light-transmitting holes respectively have different diameters and are disposed on the at least one shading cover along the moving path.

33. The adjustable shading module as claimed in claim 19, wherein the moving path is perpendicular to the optical axis.

34. The adjustable shading module as claimed in claim 19, wherein the moving path is a straight line or a curve.

35. The adjustable shading module as claimed in claim 19, wherein the optical lens assembly comprises three to eight lenses with refractive power and satisfies:
0.1≤InTL/HOS≤0.95;
wherein InTL is a distance from the object-side surface of one of the lenses that is the closest to the object side to an image-side surface of one of the lenses that is the closest to the image side.

36. The adjustable shading module as claimed in claim 19, wherein the optical lens assembly further comprises an aperture and satisfies:
0.2≤InS/HOS≤1.1;
wherein InS is a distance between the aperture and an image plane of the optical lens assembly on the optical axis.
